(19) United States
(12) Patent Application Publication
(10) Pub. No.: US 2014/0174524 A1
(43) Pub. Date: Jun. 26, 2014

(54) PHOTOELECTRIC CONVERSION ELEMENT, METHOD FOR MANUFACTURING THE SAME, ELECTRONIC APPARATUS, COUNTER ELECTRODE FOR PHOTOELECTRIC CONVERSION ELEMENT, AND ARCHITECTURE

(71) Applicants: Yoshiaki Obana, Kanagawa (JP); Keishi Tada, Kanagawa (JP); Harumi Takada, Kanagawa (JP); Ryo Sasaki, Kanagawa (JP); Yusuke Suzuki, Kanagawa (JP)

(72) Inventors: Yoshiaki Obana, Kanagawa (JP); Keishi Tada, Kanagawa (JP); Harumi Takada, Kanagawa (JP); Ryo Sasaki, Kanagawa (JP); Yusuke Suzuki, Kanagawa (JP)

(73) Assignee: Sony Corporation, Tokyo (JP)

(21) Appl. No.: 14/130,126

(22) PCT Filed: Jun. 22, 2012
(86) PCT No.: PCT/JP2012/066631

§ 371 Date: Dec. 30, 2013

(30) Foreign Application Priority Data
Jul. 8, 2011 (JP) 2011-151836

(51) Int. Cl. H01G 9/20

(52) U.S. Cl. CPC H01G 9/2022
USPC 136/256; 438/98

(57) ABSTRACT

Provided are a counter electrode, which is excellent in electrolytic solution resistance and electrical conductivity, and which is capable of corresponding to an application process carried out by pattern printing during a manufacturing process, a photoelectric conversion element using the counter electrode, and a method for manufacturing the same. A dye-sensitized photoelectric conversion element has a structure in which an electrolyte layer is filled between a porous electrode to which a photosensitizing dye is adsorbed and a counter electrode. The counter electrode includes: a metal counter electrode; a conductive primer layer that contains conductive carbon, and at least one resin selected among a polyamide imide resin, a polyamide resin, and polyimide resin as a binder resin; and a catalyst layer containing conductive carbon and an inorganic binder. The metal counter electrode and the catalyst layer are formed to come into close contact with each other through the conductive primer layer.

### TECHNICAL FIELD

The present invention relates to a photoelectric conversion element, a method for manufacturing the same, an electronic apparatus, a counter electrode for a photoelectric conversion element, and an architecture, and particularly to, a photoelectric conversion element that is suitable for use in a dye-sensitized solar cell, a method for manufacturing the same, an electronic apparatus using the photoelectric conversion element, and a counter electrode for a photoelectric conversion element.

### BACKGROUND ART

A solar cell that is a photoelectric conversion element that converts solar light to electrical energy uses the solar light as an energy source, and thus the solar cell has an extremely less influence on the global environment, and thus spreading has been further expected.

As a solar cell in the related art, a crystalline silicon-based solar cell using single crystalline or polycrystalline silicon, and an amorphous silicon-based solar cell have been mainly used.

On the other hand, a dye-sensitized solar cell suggested by Gratzel et al. in 1991 may obtain high photoelectric conversion efficiency. In addition, differently from the silicon-based solar cell in the related art, a large-sized device is not necessary during manufacturing, and the dye-sensitized solar cell may be manufactured with the low cost, and thus the dye-sensitized solar cell has attracted attention (for example, refer to Non-Patent Document 1).

Generally, the dye-sensitized solar cell has a structure in which an electrolyte layer formed from an electrolytic solution is filled between porous electrodes formed from titanium oxide (TiO₂) to which a photosensitizing dye is bonded. As the electrolytic solution, an electrolytic solution obtained by dissolving an electrolyte containing redox species such as iodine (I) and an iodine ion (I⁻) in a solvent is frequently used.

In the related art, mainly, a platinum layer has been used as a counter electrode of the dye-sensitized solar cell, because the platinum layer has both of excellent catalytic action and corrosion resistance, and the like. For formation of the platinum layer, a sputtering method, a wet method in which after application of a chloroplatinic acid solution, chloroplatinic acid is decomposed by heating to separate platinum, and the like are used. Generally, the platinum layer is excellent in catalytic activity, corrosion resistance, electrical conductivity, and the like, but platinum may be dissolved depending on an electrolyte that is used, and thus there is a concern that a deterioration in power generation characteristics may be caused. In addition, since platinum is rare in an aspect of resources and is expensive, and a high-vacuum process or a high-temperature process is necessary for formation of the platinum layer, there is a problem in that a large-sized production facility is necessary.

To solve the problem, in recent years, a dye-sensitized solar cell excellent in long-term stability has been developed using carbon, which is chemically stable, as a material of the counter electrode (for example, refer to Patent Document 1 to Patent Document 4).

As a carbon used as a material of the counter electrode, particularly, carbon black having high catalytic activity is selected. The carbon black is mixed in a solvent or the like to form a carbon paste, and then the carbon paste is applied to a substrate and is dried to form a catalyst layer, whereby the counter electrode is formed. It has been reported that the carbon counter electrode formed using the method realizes performance close to that of the platinum counter electrode (for example, refer to Non-Patent Document 2).

When forming the catalyst layer of the carbon counter electrode, a doctor blade method is generally used as a method for applying the carbon paste to the substrate. However, in a current collector wire type dye-sensitized solar cell including a current collector wire on an opposite porous electrode side, the porous electrode and the counter electrode are configured to overlap each other through an electrolytic solution. In addition, it is necessary for a distance between the porous electrode and the counter electrode to be as small as possible so as to suppress resistance. Therefore, in a case where the current collector wire has a shape protruding further than the porous electrode, it is necessary for the catalyst layer of the counter electrode to have a shape capable of avoiding interference with the current collector wire. Accordingly, the catalyst layer is formed on a substrate in a predetermined pattern. Particularly, in the case of the carbon counter electrode, since the catalyst layer is formed by applying the carbon paste onto the substrate, a method for forming a catalyst according to pattern printing is selected.

With regard to the pattern printing, a screen printing method capable of performing large quantity of printing at the low cost is used. To print the carbon paste on a substrate in a satisfactory manner according to the screen printing method, it is necessary to allow the carbon paste that is a printing solution to have appropriate thixotropy. Accordingly, an organic binder such as ethyl cellulose is mixed in the carbon paste in order to allow the carbon paste to have appropriate thixotropy. It has been reported that when the carbon paste is used as a printing solution and is printed on a substrate according to the screen printing method to form the catalyst layer, the carbon counter electrode may be formed with a satisfactory printing property and a desired shape (for example, refer to Patent Document 4).

### CITATION LIST

### Patent Document

Patent Document 1: JP 2003-142168 A

Patent Document 2: JP 2004-111216 A

Patent Document 3: JP 2004-127849 A

Patent Document 4: JP 2004-152747 A

### Non-Patent Document

Non-Patent Document 1: Nature, 353, p. 737-740, 1991

Non-Patent Document 2: J Electrochem Soc., 153(12), (2006) A2255

### SUMMARY OF THE INVENTION

### Problems to be Solved by the Invention

However, in the carbon counter electrode suggested in Patent Document 4, since the organic binder such as ethyl cellulose remains in the catalyst layer, micropores are not sufficiently present in the catalyst layer. Therefore, when the carbon counter electrode is applied to the counter electrode of the dye-sensitized solar cell, the electrolytic solution does not sufficiently penetrate into the catalyst layer. As a result, there is a problem in that electron exchange between the catalyst layer and the electrolytic solution is not effectively carried out, and electrons generated in the porous electrode of the dye-sensitized solar cell may not be effectively taken out to the outside. In addition, there is a problem in that the carbon counter electrode suggested in Patent Document 4 is short of electrolytic solution resistance, and in a case of being applied to the counter electrode of the dye-sensitized solar cell and the like, the carbon counter electrode may not endure for a long-term use.

Accordingly, a problem to be solved by the present disclosure is to provide a counter electrode for a photoelectric conversion element, which is excellent in electrolytic solution resistance and electrical conductivity, and which is capable of corresponding to an application process carried out by pattern printing during a manufacturing process.

In addition, another problem to be solved by the present disclosure is to provide a photoelectric conversion element using the excellent counter electrode for a photoelectric conversion element as described above, and a method for manufacturing the photoelectric conversion element.

In addition, still another problem to be solved by the present disclosure is to provide a high-performance electronic apparatus using the excellent photoelectric conversion element as described above.

### Solutions to Problems

To solve the above-described problems, according to an aspect of the present disclosure, there is provided a counter electrode for a photoelectric conversion element. The counter electrode includes a metal counter electrode, a conductive intermediate layer provided on the metal counter electrode, and a catalyst layer provided on the conductive intermediate layer.

In addition, according to another aspect of the present disclosure, there is provided a photoelectric conversion element including an electrolyte layer between a porous electrode and a counter electrode. The counter electrode includes a metal counter electrode, a conductive intermediate layer provided on the metal counter electrode, and a catalyst layer provided on the conductive intermediate layer.

In addition, according to still another aspect of the present disclosure, there is provided a method for manufacturing a photoelectric conversion element including an electrolyte layer between a porous electrode and a counter electrode. The method includes forming the counter electrode by forming a conductive intermediate layer on a metal counter electrode, and forming a catalyst layer on the conductive intermediate layer.

In addition, according to still another aspect of the present disclosure, there is provided an electronic apparatus including at least one photoelectric conversion element. The photoelectric conversion element includes an electrolyte layer between a porous electrode and a counter electrode. The counter electrode includes a metal counter electrode, a conductive intermediate layer provided on the metal counter electrode, and a catalyst layer provided on the conductive intermediate layer.

In addition, according to still another aspect of the present disclosure, there is provided an architecture including at least one photoelectric conversion element and/or a photoelectric conversion element module in which a plurality of the photoelectric conversion elements are electrically connected to each other. The photoelectric conversion element includes an electrolyte layer between a porous electrode and a counter electrode. The counter electrode includes a metal counter electrode, a conductive intermediate layer provided on the metal counter electrode, and a catalyst layer provided on the conductive intermediate layer.

In the present disclosure, typically, the porous electrode may be constituted by fine particles composed of a semiconductor. Preferably, the semiconductor includes titanium oxide (TiO₂), particularly, anatase type TiO₂.

As the porous electrode, a porous electrode constituted by so-called core shell-structured fine particles may be used. As the porous electrode, preferably, a porous electrode constituted by fine particles, each having a core formed from a metal and a shell which surrounds the core and is formed from a metal oxide, may be used. When using this porous electrode, in a case of providing the electrolyte layer between the porous electrode and the counter electrode, electrolyte inside the electrolyte layer does not come into contact with the core formed from a metal of metal/metal oxide fine particles, and thus dissolution of the porous electrode due to the electrolyte may be prevented. Accordingly, gold (Au), silver (Ag), copper (Cu), and the like, which are difficult to use as a metal constituting the core of the metal/metal oxide fine particles in the related art and which have a large surface plasmon resonance effect, may be used, and thus the surface plasmon resonance effect may be sufficiently obtained in photoelectric conversion. In addition, as an electrolyte of an electrolytic solution, iodine-based electrolyte may be used. As the metal that constitutes the core of metal/metal oxide fine particles, platinum (Pt), palladium (Pd), and the like may be used. As the metal oxide that constitutes the shell of metal/metal oxide fine particles, a metal oxide, which is not dissolved in an electrolyte that is used, is used and is selected according to necessity. As the metal oxide, preferably, at least one kind of metal oxide selected from a group consisting of titanium oxide (TiO₂), tin oxide (SnO₂), niobium oxide (Nb₂O₅), and zinc oxide (ZnO) is used, but the metal oxide is not limited thereto. In addition, metal oxides such as tungsten oxide (WO₃) and strontiumtitanate (SrTiO₃) may be used. A particle size of the fine particles is appropriately selected, but the particle size is preferably 1 nm to 500 nm. In addition, a particle size of the core of the fine particles is also appropriately selected, but the particle size is preferably 1 nm to 200 nm.

An electrolytic solution is typically used to constitute the electrolyte layer. As the electrolytic solution, an electrolytic solution that is known in the related art may be used, and is selected according to necessity. From the viewpoint of preventing volatilization of the electrolytic solution, a low volatile electrolytic solution, for example, an ionic liquid based electrolytic solution in which an ionic liquid is used as a solvent is used. As the ionic liquid, an ionic liquid that is known in the related art may be used and is selected according to necessity.

In the present disclosure, as the conductive intermediate layer, any conductive intermediate layer is possible as long as a binding property between the metal counter electrode and the catalyst layer are satisfactory and a conductive pass is retained. The conductive intermediate layer is typically constituted by a material containing a conductive material at least at apart thereof, and is formed by laminating the material containing the conductive material at least at a part thereof on the metal counter electrode.

As the conductive material, basically, any conductive material is possible as long as the conductive material has electrical conductivity. As the conductive material, a conductive material having high electrolyte resistance is preferable, and a conductive material having high resistance against iodine (I) is particularly preferable. Typical examples of a material of the conductive material include a metal, carbon, a conductive polymer, and the like. As the metal, a metal simple substance, an alloy, and the like may be exemplified. Examples of the metal simple substance include silver (Ag), copper (Cu), gold (Au), aluminum (Al), magnesium (Mg), tungsten (W), cobalt (Co), zinc (Zn), nickel (Ni), potassium (K), lithium (Li), iron (Fe), platinum (Pt), tin (Sn), chromium (Cr), titanium (Ti), mercury (Hg), and the like. Examples of the alloy include a binary alloy, a ternary alloy, and the like which are obtained in combination of the metal simple substances, and example of the alloy include an aluminum alloy, a titanium alloy, stainless steel, brass, bronze, nickel silver, cupronickel, manganin, Nichrome, and the like. As other metals, for example, fluorine-doped tin oxide, antimony oxide, indium tin oxide, indium gallium zinc oxide, potassium titanate, and the like may be exemplified, but the metal is not limited thereto. In addition, as carbon, conductive carbon and the like may be exemplified, and examples of carbon include carbon black, graphite, amorphous carbon (glassy carbon), activated charcoal, petroleum coke, fullerenes such as C₆₀ and C₇₀, single-layer or multi-layer carbon nanotube, and the like, but the carbon is not limited thereto. In addition, examples of the conductive polymer include polyaniline, polypyrrole, polythiophene, and the like, but the conductive polymer is not limited thereto.

In addition, as a shape of the conductive material, a plate shape, a particle shape, a linear shape, a rod shape, a needle shape, a fiber shape, a sheet shape, and the like may be exemplified. The conductive material is configured by appropriately selecting the above-described materials and shapes. Specific examples of the conductive material according to the shape thereof include conductive particles, a conductive plate, a conductive thin film, a conductive fiber, a conductive sheet, a conductive whisker, and the like. In addition, the conductive material may have a configuration in which a conductive material is laminated on an insulating material having the above-described shape, or may be particles obtained by coating a metal on a surface of an inorganic material such as glass beads and zirconia beads, and the like.

In addition, particularly preferably, the conductive intermediate layer is configured in combination of the conductive material and a binder. In addition, the conductive intermediate layer is preferably formed by applying a mixed solution of the conductive material, a resin, and a solvent on the metal counter electrode, and by drying the applied mixed solution. In this case, the conductive material is appropriately selected from the materials described above, and the conductive carbon particles are specially selected in consideration of electrolyte resistance, application properties, and the like. As the conductive carbon particles, preferably, carbon black may be exemplified. The carbon black is black amorphous carbon particles having an average particle size of a primary particle size is 3 nm to 500 nm. In addition, it is preferable that the carbon black have high electrical conductivity. In addition, it is preferable that the carbon black be easy to form a structure. In addition, it is preferable that the average particle size of the primary particle size of the carbon black be 3 nm to 100 nm, more preferably 5 nm to 80 nm, and still more preferably 8 nm to 70 nm. Specific example of the carbon black include ketjen black, furnace black, lamp black, channel black, acetylene black, thermal black, and the like. Among these, the ketjen black, which has a hollow shape and a large actual surface area and has high electrical conductivity and which is easy to form a structure, is preferable, but the carbon black is not limited thereto.

As the binder that is used to constitute the conductive intermediate layer, basically, any binder may be used as long as the binder has high heat resistance and high electrolytic solution resistance. Specific examples of the binder include an inorganic binder and a resin binder. Examples of the inorganic binder include a metal semiconductor, a metal oxide, a glass composition, and the like. Examples of the metal semiconductor include titanium oxide (TiO₂), tin oxide (SnO₂), indium oxide (In₂O₃), and the like. Examples of the metal oxide include aluminum oxide (Al₂O₃), zirconium oxide (ZrO₂), silicon oxide (SiO₂), spinel (MgAl₂O₄), and the like. Examples of the glass composition include glass frit, sodium silicate (water glass), and the like. As other inorganic binders, for example, silica sol-gel or the like is preferable. In the case of the resin binder, at least one resin selected from a group consisting of a polyamide imide resin, a polyamide resin, and a polyimide resin is preferable. Particularly, among the above-described binders, at least one resin selected from a group consisting of the polyamide imide resin, the polyamide resin, and the polyimide resin is more preferably selected. The reason is that among the above-described binders, these resins are not affected by an electrolyte, and have high binder performance capable of being bonded to the conductive particles in a stable electrochemical manner.

The polyamide imide has an amide imide structure unit expressed by Chemical Formula (1).

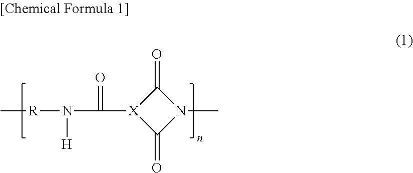

The polyamide imide has a structure in which cyclic imide bond and amide bond are included in a polymer chain. Generally, the polyamide imide may be obtained by polymerizing trimellitic acid hydrate monochloride as an acid component monomer, and an amine component.

The polyamide has an amide structure unit expressed by Chemical Formula (2).

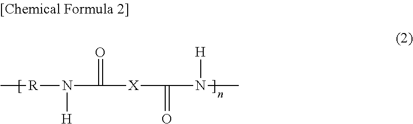

The polyamide is a polymer in which a plurality of monomers are coupled to each other by an amide bond. In the polyamide, aramid that is completely aromatic polyamide having a benzene nucleus in a main chain is particularly preferable. Examples of the aramid include para-based aramid such as polyparaphenylene terephthalic acid obtained by co-polycondensation of p-phenylenediamine and terephthalic acid chloride, meta-based aramid such as polymetaphenylene isophthalamide obtained by co-polycondensation of m-phenylenediamine and isophthalic acid chloride, and the like.

The polyimide has an imide structure unit expressed by Chemical Formula (3).

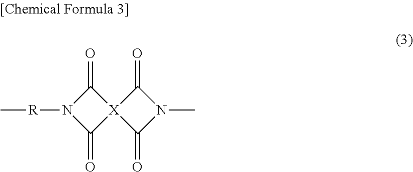

The polyimide is aromatic polyimide in which aromatic compounds are directly connected by an imide bond. The polyimide may be obtained by subjecting polyamide acid (polyamic acid) obtained by polymerizing tetracarboxylic dianhydride and diamine as raw materials in an equimolar ratio to a cyclodehydration reaction.

Basically, the electronic apparatus may be any electronic apparatus, and includes both of a portable type electronic apparatus and a stationary type electronic apparatus. However, specific examples of the electronic apparatus include a cellular phone, a mobile apparatus, a robot, a personal computer, an in-vehicle apparatus, various household electric appliances, and the like. In this case, for example, the photoelectric conversion element is a solar cell that is used as a power supply of these electronic apparatuses.

Typically, the architecture represents a large-sized architecture such as a building and condominium, but the architecture is not limited thereto. Basically, the architecture may be any architecture as long as the architecture is a structure that is built to have an external wall surface. Specific examples of the architecture include a detached house, an apartment, a station building, a school building, a government office building, a sports ground, a baseball stadium, a hospital, a church, a factory, a warehouse, a shed, a garage, a bridge, and the like. Particularly, a structure that is built to have at least one window part (for example, a glass window) or a light collection part is preferable.

With regard to the photoelectric conversion element and/or a photoelectric conversion element module in which a plurality of the photoelectric conversion elements are electrically connected to each other, which are provided to the architecture, the photoelectric conversion element or the photoelectric conversion element module, which is provided to the window part or the light collection part, is preferably configured to be interposed between two transparent plates and to be fixed as necessary. Typically, the photoelectric conversion element and/or the photoelectric conversion element module are configured to be interposed between two glass plates and to be fixed as necessary.

As a transparent material constituting the transparent plates, basically, any material may be used as long as this material is transparent so that light is easy to penetrate therethrough. Specific examples of the transparent material include a transparent inorganic material, a transparent resin, and the like. Examples of the transparent inorganic material include quartz glass, borosilicate glass, phosphate glass, soda-lime glass, and the like. Examples of the transparent resin include polyethylene terephthalate, polyethylene naphthalate, polybutylene terephthalate, acetyl cellulose, tetraacetyl cellulose, polyphenylene sulfide, polycarbonate, polyethylene, polypropylene, polyvinylidene fluoride, brominated phenoxy, aramids, polyimides, polystyrenes, polyarylates, polysulfones, polyolefins, and the like. However, the transparent material is not limited thereto.

In addition, members between which the photoelectric conversion element or the photoelectric conversion element module is interposed are not limited to the transparent plates, and a spherical body, an ellipsoid body, a polyhedron, a cone, a frustum of cone, a column body, a lens body, and the like, which are formed from a transparent material, may be used as the members.

Most typically, the photoelectric conversion element is configured as a solar cell. In addition to the solar cell, the photoelectric conversion element may be configured as, for example, an optical sensor, and the like.

### Effects of the Invention

According to the present disclosure, when the counter electrode including the metal counter electrode, the conductive intermediate layer, and the catalyst layer is used in the photoelectric conversion element, since the counter electrode has excellent electrolytic solution resistance and electrical conductivity, the counter electrode is capable of being manufactured at the low cost and is capable of corresponding to an application process carried out by pattern printing during a manufacturing process. In addition, when the photoelectric conversion element is used, a high-performance electronic apparatus and the like may be realized.

### BRIEF DESCRIPTION OF DRAWINGS

FIG. 1 is a cross-sectional diagram illustrating a counter electrode for a dye-sensitized photoelectric conversion element according to a first embodiment.

FIG. 2A is a photograph substituted for a drawing, which illustrates conductive primer layers before baking of counter electrodes for a dye-sensitized photoelectric conversion element according to Examples 1, 4, 5, and 6, and FIG. 2B is a photograph substituted for a drawing, which illustrates the conductive primer layers after baking of the counter electrodes for a dye-sensitized photoelectric conversion element according to Examples 1, 4, 5, and 6.

FIG. 3A is a photograph substituted for a drawing, which illustrates conductive primer layers before baking of counter electrodes for a dye-sensitized photoelectric conversion element according to Comparative Examples 1 to 3, and FIG. 3B is a photograph substituted for a drawing, which illustrates the conductive primer layers after baking of the counter electrodes for a dye-sensitized photoelectric conversion element according to Comparative Examples 1 to 3.

FIG. 4 is a cross-sectional diagram illustrating a dye-sensitized photoelectric conversion element according to a second embodiment.

FIG. 5 is a cross-sectional diagram illustrating a counter electrode for a dye-sensitized photoelectric conversion element according to a third embodiment.

FIG. 6 is a cross-sectional diagram illustrating a dye-sensitized photoelectric conversion element according to a fourth embodiment.

FIG. 7 is a cross-sectional diagram illustrating a counter electrode for a dye-sensitized photoelectric conversion element according to a fifth embodiment.

FIG. 8 is a cross-sectional diagram illustrating a dye-sensitized photoelectric conversion element according to a sixth embodiment.

FIG. 9 is a cross-sectional diagram illustrating a dye-sensitized photoelectric conversion element according to a seventh embodiment.

FIG. 10 is a cross-sectional diagram illustrating a dye-sensitized photoelectric conversion element according to an eighth embodiment.

FIG. 11A is a cross-sectional diagram illustrating a method for manufacturing the dye-sensitized photoelectric conversion element according to the eighth embodiment, and FIG. 11B is a cross-sectional diagram illustrating the method for manufacturing the dye-sensitized photoelectric conversion element according to the eighth embodiment.

FIG. 12A is a cross-sectional diagram illustrating the method for manufacturing the dye-sensitized photoelectric conversion element according to the eighth embodiment, and FIG. 12B is a cross-sectional diagram illustrating the method for manufacturing the dye-sensitized photoelectric conversion element according to the eighth embodiment.

FIG. 13 is a cross-sectional diagram illustrating the method for manufacturing the dye-sensitized photoelectric conversion element according to the eighth embodiment.

FIG. 14 is a cross-sectional diagram illustrating an example of a dye-sensitized photoelectric conversion element which the present inventors have examined.

FIG. 15 is a cross-sectional diagram illustrating an example of a dye-sensitized photoelectric conversion element which the present inventors have examined.

### MODE FOR CARRYING OUT THE INVENTION

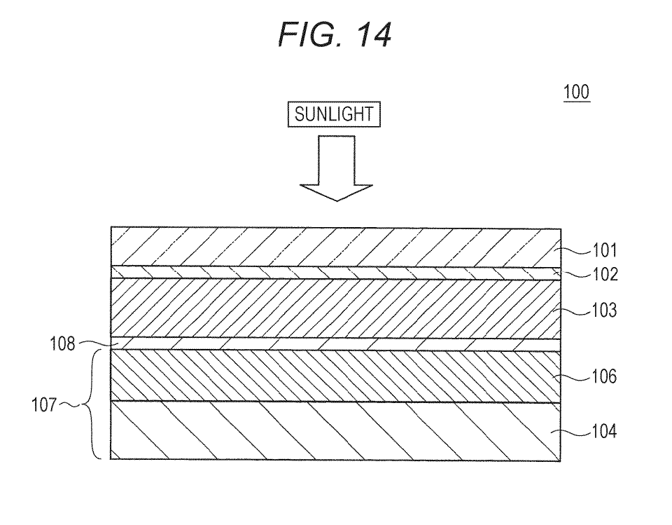

FIG. 14 is a cross-sectional diagram of a main portion, which illustrates a dye-sensitized photoelectric conversion element 100 that has been examined by the present inventors.

As illustrated in FIG. 14, in the dye-sensitized photoelectric conversion element 100, a transparent electrode 102 that is composed of an FTO layer is provided on one main surface of a transparent substrate 101, and a porous electrode 103 constituted by a TiO₂ sintered body is provided on the transparent electrode 102. One kind or a plurality of kinds of photosensitizing dyes (not illustrated) are bonded to the porous electrode 103. On the other hand, a catalyst layer 106 is provided on one main surface of a metal counter electrode 104, whereby a counter electrode 107 is constituted. In addition, an electrolyte layer 108, which is formed from an electrolytic solution using redox species of I⁻/I₃⁻ as a redox couple, is filled between the porous electrode 103 and the counter electrode 107, and outer peripheral portions of the transparent substrate 101 and the metal counter electrode 104 are sealed with a sealing material (not illustrated).

When light is incident to the porous electrode 103, the dye-sensitized photoelectric conversion element 100 operates as a battery in which the transparent electrode 102 is set as a negative electrode, and the counter electrode 107 is set as a positive electrode.

Electrons generated by a photosensitizing action reach the transparent electrode 102 through the porous electrode 103 and are transmitted to an external circuit, and thus it is necessary to take out the generated electrons to the outside without loss of energy so as to increase photoelectric conversion efficiency of the dye-sensitized photoelectric conversion element 100. Therefore, it is necessary to reduce an internal resistance of the transparent electrode 102 that is an electron taking-out channel as much as possible to suppress resistance loss. However, in the transparent electrode 102, transmittance loss of light is large, and thus it is necessary for the transparent electrode 102 to be formed in an ultrathin thickness so as to optimize the use of the light incident to the transparent substrate 101. In this case, the resistance of the transparent electrode 102 relatively increases. Particularly, the transparent electrode 102 in the dye-sensitized photoelectric conversion element 100 having a practical size has a size of several tens cm² to several m², and thus an internal resistance of the transparent electrode 102 considerably increases.

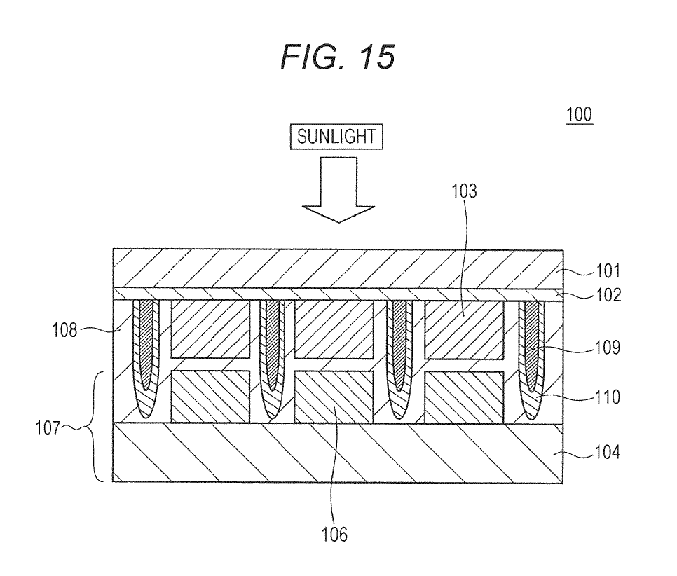

FIG. 15 is a cross-sectional diagram of a main portion, which illustrates the dye-sensitized photoelectric conversion element 100 having a current collector wire that has been further examined by the present inventors.

As illustrated in FIG. 15, a plurality of porous electrodes 103, which are rectangular column bodies divided in a strip shape, are provided on the transparent electrode 102 with a constant distance. A current collector wire 109, which is a column body formed from a material having high electrical conductivity such as silver (Ag) and aluminum (Al), is formed on the transparent electrode 102 at a position of the distance. In addition, a current collector wire protective layer 111 is provided on a surface of the current collector wire 109 so as to protect the current collector wire 109 from an electrolytic solution. The current collector wire 109 has a shape protruding toward the counter electrode 107 side further than the porous electrode 103. On the other hand, a plurality of catalyst layers 106, which are rectangular column bodies divided in a strip shape, are formed on one main surface of the metal counter electrode 104, whereby the counter electrode 107 is constituted. Each of the catalyst layers 106 is formed on the metal counter electrode 104 at a position opposite to the porous electrode 103. In addition, an electrolyte layer 108 is filled between the porous electrode 103 and the counter electrode 107, whereby the dye-sensitized photoelectric conversion element 100 is constituted.

Since the current collector wire 109 is provided on the transparent electrode 102, the generated electrons preferentially pass through the current collector wire 109 having a low resistance value, and thus the energy loss when taking out the electrons to the outside is suppressed. In addition, in a case where a large current flows through the current collector wire 109 due to an increase in size of the dye-sensitized photoelectric conversion element 100, it is necessary to increase a cross-sectional area of the current collector wire 109 so as to further reduce the energy loss when taking out the generated electrons to the outside. Due to this, the current collector wire 109 is formed in a shape protruding toward the counter electrode 107 side further than the porous electrode 103. On the other hand, the counter electrode 107 has a configuration in which the catalyst layer 106 is laminated on the metal counter electrode 104. The counter electrode 107 and the porous electrode 103 are made to be opposite to each other, and the electrolyte layer 108 is formed therebetween, whereby the dye-sensitized photoelectric conversion element 100 is constituted. At this time, when the thickness of the electrolyte layer 108 is set to be larger than necessary in order for the protruded current collector wire 109 and the catalyst layer 106 not to come into contact with each other, an increase in a direct current resistance value is caused, and thus the photoelectric conversion efficiency of an element significantly decreases. Therefore, it is necessary to provide the catalyst layer 106 having a predetermined pattern on the metal counter electrode 104 at a position at which the current collector wire 109 is not provided on the opposite transparent electrode 102 so as to provide the porous electrode 103 and the counter electrode 107 to be adjacent to each other as close as possible. A method for providing the catalyst layer 106 having a predetermined pattern on the metal counter electrode 104 is as follows. Particularly, in a case where the counter electrode 107 is set as the carbon counter electrode, typically, the catalyst layer 106 is formed on the metal counter electrode 104 by pattern printing.

With regard to the pattern printing, generally, a screen printing method capable of performing large quantity of printing at the low cost is used. To print the carbon paste on the metal counter electrode 104 in a satisfactory manner according to the screen printing method, it is necessary to allow the carbon paste that is a printing solution to have appropriate thixotropy. Accordingly, an organic binder such as ethyl cellulose is mixed in the carbon paste in order to allow the carbon paste to have appropriate thixotropy. The carbon paste is printed on the metal counter electrode 104 in a desired pattern according to the screen printing method to form the catalyst layer 106, and the printed carbon paste is heated and dried as necessary, thereby forming the counter electrode 107 that is the carbon counter electrode.

However, in the carbon counter electrode that is formed by this method, since the organic binder such as ethyl cellulose remains in the catalyst layer 106, micropores are not sufficiently present in the catalyst layer 106. Therefore, when the counter electrode 107 is applied to the counter electrode of the dye-sensitized photoelectric conversion element 100, the electrolytic solution does not sufficiently penetrate into the catalyst layer 106. That is, there is a problem in that electron exchange between the catalyst layer 106 and the electrolytic solution is not effectively carried out, and electrons generated in the porous electrode 103 of the dye-sensitized photoelectric conversion element 100 may not be effectively taken out to the outside.

Therefore, to solve this problem, the present inventors have baked the catalyst layer after forming the carbon counter electrode to remove the organic binder, thereby forming micropores in the catalyst layer. However, when applying this method, binding strength between the catalyst layers and binding strength between the catalyst layer and the metal counter electrode after baking become significantly weak. Particularly, the problem of binding property between the catalyst layer and the metal counter electrode causes a problem in which the catalyst layer is peeled from the metal counter electrode, which leads to breakage of the counter electrode. Furthermore, it cannot be said that durability against a deterioration with the passage of time due to contact between the catalyst layer of the carbon counter electrode and the electrolytic solution is high.

Furthermore, as another method for solving the problem, the present inventors have mixed an inorganic binder such as TiO₂ in the catalyst layer to form the carbon counter electrode. According to this method, particularly, the binding strength between the catalyst layer and the metal counter electrode was improved while sufficiently forming the micropores in the catalyst layer. However, the present inventors have faced an additional problem in that when increasing an amount of the inorganic binder added to the catalyst layer to improve the binding property between the catalyst layer and the metal counter electrode, a catalytic active spot in the carbon counter electrode decreases, and thus the electrons generated in the porous electrode of the dye-sensitized photoelectric conversion element may not be taken out to the outside in an effective manner.

The present inventors have extensively studied to solve the above-described problems. During the course of the study, the present inventors have found the following finding. In the carbon counter electrode, when a conductive intermediate layer formed from a conductive material and a resin is provided between the catalyst layer and the metal counter electrode, the binding strength between the catalyst layer and the metal counter electrode may be made to be strong through the conductive intermediate layer while maintaining the catalytic performance of the catalyst layer to be high. As a result, the present inventors have devised the invention.

Hereinafter, embodiments to carry out the invention (hereinafter, referred to as embodiments) will be described. Description will be given in the following order.

1. First Embodiment (Counter Electrode for Dye-Sensitized Photoelectric Conversion Element, and Method for Manufacturing the same)

2. Second Embodiment (Dye-Sensitized Photoelectric Conversion Element, and Method for Manufacturing the same)

3. Third Embodiment (Counter Electrode for Dye-Sensitized Photoelectric Conversion Element, and Method for Manufacturing the same)

4. Fourth Embodiment (Dye-Sensitized Photoelectric Conversion Element, and Method for Manufacturing the same)

5. Fifth Embodiment (Counter Electrode for Dye-Sensitized Photoelectric Conversion Element, and Method for Manufacturing the same)

6. Sixth Embodiment (Dye-Sensitized Photoelectric Conversion Element, and Method for Manufacturing the same)

7. Seventh Embodiment (Dye-Sensitized Photoelectric Conversion Element, and Method for Manufacturing the same)

8. Eighth Embodiment (Dye-Sensitized Photoelectric Conversion Element, and Method for Manufacturing the same)

### 1. First Embodiment

[Counter Electrode for Dye-Sensitized Photoelectric Conversion Element]

First, the first embodiment will be described.

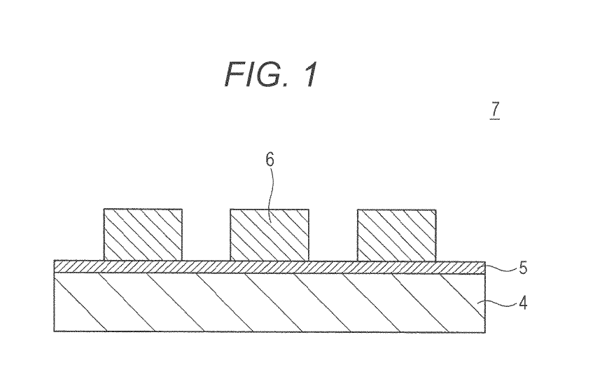

FIG. 1 is a cross-sectional diagram of a main portion, which illustrates a counter electrode 7 for a dye-sensitized photoelectric conversion element according to the first embodiment.

As illustrated in FIG. 1, in a counter electrode 7 for a dye-sensitized photoelectric conversion element (hereinafter, referred to as a counter electrode 7), a conductive primer layer 5 that is a conductive intermediate layer is laminated on one main surface of a metal counter electrode 4 to cover the entirety of the main surface, and a catalyst layer 6 is selectively provided on a surface of the conductive primer layer 5. The conductive primer layer 5 is formed to come into close contact with the metal counter electrode 4 and the catalyst layer 6.

A material that constitutes the metal counter electrode 4 may be basically any material as long as the material is composed of a metal, but a metal excellent in electrical conductivity is preferable. As the metal, a metal simple substance, an alloy, and the like may be exemplified. Examples of the metal simple substance include gold (Au), silver (Ag), copper (Cu), zinc (Zn), iron (Fe), platinum (Pt), titanium (Ti), nickel (Ni), aluminum (Al), and the like. Examples of the alloy include a binary alloy, a ternary alloy, and the like of the metal materials exemplified above, and for example, a stainless steel, a titanium alloy, a nickel alloy, and the like may be exemplified. Particularly, in a case where the conductive primer layer 5 is provided at a part of a surface of the metal counter electrode 4 on a electrolyte layer 8 side, among the above-described metals, a metal having electrolytic solution resistance is preferable, and typically, titanium (Ti), nickel (Ni), an alloy thereof, or the like are used as the material.

The conductive primer layer 5 contains a conductive material, and at least one resin selected from a group consisting of a polyamide imide resin, a polyamide resin, and a polyimide resin, and the conductive material and the resin may be appropriately selected from the materials exemplified above. The resin is preferably selected from at least one resin selected from a group consisting of the polyamide imide resin, an aramid resin, and the polyimide resin.

A ratio between the contents of the conductive material and the resin is not particularly limited, but when the total mass of the conductive primer layer 5 is set to 100%, the resin is contained preferably in the content of 5% by mass to 70% by mass, and more preferably in the content of 5% by mass to 50% by mass. In addition, as the conductive material, typically, conductive carbon is selected. As the conductive carbon, inexpensive carbon black which is composed of fine particles and has high electrical conductivity is preferable. In addition, among a plurality of kinds of the carbon blacks, ketjen black which has high electrical conductivity and is easy to form a large-sized structure is more preferable.

In a case where the counter electrode 7 is used in the dye-sensitized photoelectric conversion element, basically, the shape of the conductive primer layer 5 may be any shape as long as an electrolytic solution that constitutes the electrolyte layer 8 does not penetrate into the inside of the conductive primer layer 5, and the conductive primer layer 5 has a configuration allowing the metal counter electrode 4 and the catalyst layer 6 to be electrically conducted to each other. However, it is preferable that the conductive primer layer 5 be laminated on the surface of the metal counter electrode 4 on an electrolyte layer 8 side to cover the entirety of the surface. It is preferable that the thickness of the conductive primer layer 5 be 0.2 μm to 10 μm, more preferably 0.5 μm to 10 μm, and still more preferably 0.5 μm to 5 μm. The reason of this limitation as follows. When the thickness of the conductive primer layer 5 is less than 0.2 μm, the binding strength between the metal counter electrode 4 and the catalyst layer 6 decreases, and thus there is a concern that peeling may occur between the metal counter electrode 4 and the conductive primer layer 5 or between the catalyst layer 6 and the conductive primer layer 5. In addition, when the thickness of the conductive primer layer 5 exceeds 5 μm, the thickness of the catalyst layer 6 provided on the conductive primer layer 5 may not be set to a thickness sufficient for a catalytic action with respect to a reduction reaction, and as a result, there is a concern that the photoelectric conversion efficiency may decrease. In addition, it is preferable that the conductive primer layer 5 have small resistivity and high electrical conductivity. It is preferable that the resistivity of the conductive primer layer 5 be 0.0005 Ω·cm to 0.1 Ω·cm, more preferably 0.0005 Ω·cm to 0.05 Ω·cm, still more preferably 0.0005 Ω·cm to 0.01 Ω·cm, and further still more preferably 0.0005 Ω·cm to 0.005 Ω·cm. In a case where the conductive primer layer 5 is constituted by the conductive carbon and resin, the conductive primer layer 5 is constituted by appropriately selecting the conductive carbon and the resin among the materials exemplified above to obtain resistivity of 0.01 Ω·cm to 0.05 Ω·cm.

Basically, the catalyst layer 6 may have any configuration as long as a catalytic action with respect to a reduction reaction is provided, but a configuration containing carbon and an inorganic binder is preferable. Basically, the carbon may be any material as long as this material is composed of a carbon simple substance. As the carbon, preferably, carbon particles may be exemplified. Specific examples of the carbon particles include carbon black. It is preferable that the carbon black have a large specific surface area. In addition, it is preferable that the carbon black have high electrical conductivity. In addition, it is preferable that the carbon black be easy to form a structure. In addition, it is preferable that an average particle size of a primary particle size of the carbon black be 3 nm to 100 nm, more preferably 5 nm to 80 nm, and still more preferably 8 nm to 70 nm. Specific examples of the carbon black include ketjen black, furnace black, lamp black, channel black, acetylene black, thermal black, and the like. Among these, the ketjen black which is inexpensive and has a large specific surface area is preferable, but the carbon black is not limited thereto.

In addition to the carbon exemplified above, the carbon may be a line-shaped or rod-shaped carbon, graphite, amorphous carbon (glassy carbon), a carbon fiber, activated charcoal, petroleum coke, fullerenes such as C₆₀ and C₇₀, single-layer or multi-layer carbon nanotube, and the like.

In addition, basically, the inorganic binder may be any inorganic binder as long as this binder is not affected by an electrolyte, is electrochemically stable, and is capable of binding the carbon, but typically, a metal semiconductor, a metal oxide, a glass composition, and the like may be exemplified. Examples of the metal semiconductor include titanium oxide (TiO₂), tin oxide (SnO₂), indium oxide (In₂O₃), and the like. Examples of the metal oxide include aluminum oxide (Al₂O₃), zirconium oxide (ZrO₂), silicon oxide (SiO₂), spinel (MgAl₂O₄), and the like. Examples of the glass composition include glass frit, sodium silicate (water glass), and the like.

A ratio between the contents of the carbon and the inorganic binder is not particularly limited, but when the total mass of the catalyst layer 6 is set to 100% by mass, the inorganic binder is contained preferably in the content of 10% by mass to 60% by mass, and more preferably in the content of 15% by mass to 35% by mass. The reason of this limitation is as follows. When the content of the inorganic binder contained in the catalyst layer 6 is less than 10% by mass, the binding strength with the catalyst layer 6 significantly decreases. In addition, when the content of the inorganic binder contained in the catalyst layer 6 exceeds 60% by mass, carbon in the catalyst layer 6 decreases, and thus a catalytic active spot decreases. As a result, a catalytic action in a reduction reaction decreases, and this causes a decrease in photoelectric conversion efficiency.

The catalyst layer 6 may have any shape as long as the catalyst layer 6 is configured to be provided in contact with the conductive primer layer 5, but typically, the catalyst layer 6 is laminated on the conductive primer layer 5. It is preferable that the thickness of the catalyst layer 6 be 5 μm to 200 μm, more preferably 5 μm to 100 μm, and still more preferably 10 μm to 100 The reason of this limitation is as follows. When the thickness of the catalyst layer 6 is 5 μm or less, a capacity of reducing of redox species in an electrolytic solution that constitutes the electrolyte layer 8 decreases, and thus the photoelectric conversion efficiency decreases. In addition, the thickness of the catalyst layer 6 is 200 μm or more, electron migration inside the counter electrode 7 is not smoothly carried out.

In addition, in a case where the counter electrode 7 is used in the dye-sensitized photoelectric conversion element having a configuration in which the current collector wire 9 protrudes further than the porous electrode 3, the shape and disposition of the catalyst layer 6 are appropriately selected in order for the current collector wire 9 and the catalyst layer 6 not to come into contact with each other. Typically, a plurality of the catalyst layers 6 which are column bodies are disposed on the metal counter electrode 4 in a longitudinal cross-sectional direction with a constant distance. Examples of the shape of the bottom surface of each of the column bodies include a triangular shape, a rectangular shape, a trapezoidal shape, a polygonal shape, a circular shape, an elliptical shape, a part of these shapes, and the like. In addition, the shape of the bottom surface of the column body may be one kind of shape among the shapes exemplified above or a shape obtained in combination of the plurality of shapes. In addition, the shape and area of the bottom surface of the column body may be constant or may vary in a direction in which the column body extends. In addition, typically, a direction in which the column body extends is the vertical direction, but the column body may extend in an arbitrary angular direction. In addition, the column body may be a rectangular column body that extends in a constant direction, or a curved column body that extends while the direction varies. The shape of the catalyst layer 6 is appropriately selected from the shapes exemplified above also depending on the shapes of the current collector wire 9 and the porous electrode 3 that are provided to be opposite to the catalyst layer 6. Among the shapes exemplified above, particularly, a shape of a square column body that is a rectangular column body having a rectangular bottom is preferable, but the shape of the catalyst layer 6 is not limited thereto.

Preferably, the catalyst layer 6 is formed in such a manner that a microstructure is formed on a surface thereof to increase an actual surface area so as to improve the catalytic action with respect to the reduction reaction. The actual surface area includes mesopores of the conductive carbon that constitutes the catalyst layer 6, and the like. The actual surface area of the catalyst layer 6 in a state in which the catalyst layer 6 is formed on the conductive primer layer 5 is preferably 10 or more times an area (projection area) of an outer surface of the catalyst layer 6, and more preferably 100 or more times.

[Method for Manufacturing Counter Electrode for Dye-Sensitized Photoelectric Conversion Element]

Next, a method for manufacturing the counter electrode 7 for a dye-sensitized photoelectric conversion element according to the first embodiment will be described.

First, a metal plate that is the metal counter electrode 4 is prepared.

Next, a material containing a conductive material is laminated on the entirety of one main surface of the metal counter electrode 4 to form the conductive primer layer 5. A method for forming the conductive primer layer 5 is not particularly limited, but a wet-type film forming method is preferably used in consideration of physical properties, convenience, manufacturing cost, and the like. With regard to the wet-type film forming method, a method in which a paste-like dispersed solution is prepared, and the dispersed solution is applied or printed on the entirety of the one main surface of the metal counter electrode 4 is preferable. The application method or printing method for the dispersed solution is not particularly limited, and a known method may be used. As the application method, for example, a doctor blade method, a squeegee method, a dipping method, a spray method, a wire bar method, a spin coating method, a roller coating method, a blade coating method, a gravure coating method, and the like may be used. In addition, as the printing method, a relief printing method, an offset printing method, a gravure printing method, an intaglio printing method, a rubber plate printing method, a screen printing method, and the like may be used.

With regard to the method for forming the conductive primer layer 5, specifically, first, a paste-like dispersed solution obtained by uniformly dispersing a conductive material and a resin in a solvent is prepared, and this dispersed solution is used as slurry for the conductive primer layer 5. Next, the slurry for the conductive primer layer 5 is applied or printed on one main surface of the metal counter electrode 4 by appropriately selecting a method among the above-described various methods to form a slurry coated film for the conductive primer layer 5 on the one main surface of the metal counter electrode 4. Then, the coated film is dried to remove the solvent, and is heated as necessary to form the conductive primer layer 5 on the metal counter electrode 4.

The conductive material and the resin that are contained in the slurry for the conductive primer layer 5 may be appropriately selected from the materials exemplified above. Among the materials exemplified above, the conductive material is preferably the conductive carbon, and the resin is preferably at least one resin selected from a group consisting of the polyamide imide resin, the polyamide resin, and the polyimide resin. In addition, with regard to the content of the resin, when the total mass of the dispersed solution is set to 100% by mass, the resin is mixed preferably in the content of 5% by mass to 70% by mass, and more preferably in the content of 5% by mass to 50% by mass. In addition, as the solvent, a solvent known in the related art may be appropriately selected in accordance with an application method or a printing method of the dispersed solution.

Next, the catalyst layer 6 is formed on a surface of the conductive primer layer 5. As a method for forming the catalyst layer 6, a wet-type film forming method is used. With regard to the wet-type film forming method, a method in which a paste-like dispersed solution is prepared, and this dispersed solution is applied or printed on a part of the surface of the conductive primer layer 5 is preferable. In the wet-type film forming method, since the catalyst layer 6 is selectively formed on the surface of the conductive primer layer 5, it is necessary to carry out film formation by pattern application. A screen printing method is preferably used for the film formation by the pattern application. With regard to the method for forming the catalyst layer 6, specifically, for example, a paste-like dispersed solution obtained by uniformly dispersing carbon, an organic binder, and an inorganic binder in a solvent is prepared, and this dispersed solution is used as paste for screen printing.

Next, the paste for screen printing as a coating material is screen-printed on the surface of the conductive primer layer 5 to form a plurality of coated films having a square column shape on the surface of the conductive primer layer 5 with a predetermined distance therebetween, thereby obtaining the metal counter electrode 4 having a coated film on the conductive primer layer 5. Next, the coated film that is obtained is baked. The reason of carrying out the baking is as follows. When the coated film is baked, the catalyst layer 6 in which carbons are electrically connected to each other and thus mechanical strength is high, and a binding property with the conductive primer layer is high may be obtained. In addition, when the coated film is baked, the organic binder in the coated film is removed, and thus pores are formed in the catalyst layer 6 that is obtained, and the actual surface area of the catalyst layer 6 increases.

The carbon and the inorganic binder that are mixed in the paste for screen printing may be appropriately selected from the materials exemplified above, but carbon black is preferably selected as the carbon, and titanium. oxide (TiO₂) is preferably selected as the inorganic binder.

With regard to the content of the inorganic binder that is mixed in the paste for screen printing, when the total mass of the paste for screen printing is set to 100%, the inorganic binder is preferably mixed in the content of 5% by mass to 50% by mass, and more preferably in the content of 10% by mass to 30% by mass.

In addition, it is preferable that the organic binder allows the paste for screen printing to exhibit thixotropy through the mixing. This is because when the paste for screen printing has appropriate thixotropy, satisfactory screen printing is realized. Specific examples of the organic binder include ethyl cellulose, carboxymethyl cellulose, methyl cellulose, hydroxyethyl cellulose, polyethylene oxide, polyvinyl pyrrolidone, carboxylvinyl polymer, and the like, but the organic binder is not limited thereto. In addition, the rheology of the paste for screen printing may be appropriately controlled by changing the content of the organic binder that is mixed. With regard to the content of the organic binder that is mixed in the paste for screen printing, when the total mass of the paste for screen printing is set to 100% by mass, it is preferable that the organic binder be mixed in the content of 5% by mass to 60% by mass, and more preferably in the content of 10% by mass to 30% by mass. The reason of this limitation is as follows. When the organic binder that is mixed-in is less than 5% by mass, the thixotropy is not effectively exhibited in the paste for screen printing, and when the organic binder that is mixed-in exceeds 60% by mass, the binding strength of the catalyst layer 6 that is formed after baking significantly decreases.

In addition, as the solvent, a solvent having a high boiling point is preferable to realize satisfactory printing in the screen printing. Specific examples of the solvent include terpineol, 2-(2-n-butoxy) ethanol, 1-phenoxypropane-2-ol, butyl carbitol, and the like. The boiling point of the solvent is preferably 200° C. or higher, but the boiling point is not limited thereto. In addition, a solvent having a low boiling point may be mixed in the solvent having the high boiling point to maintain the carbon material, the organic binder, and the like in a highly dispersed state, or to improve application properties during the screen printing.

In addition, a range of baking temperature is not particularly limited, but from the viewpoint of a necessity of removing the organic binder, the baking temperature is preferably 200° C. to 800° C., and more preferably 300° C. to 500° C. The reason of this limitation is as follows. When the baking temperature is lower than 200° C., there is a concern that the organic binder may not be removed, and when the baking temperature exceeds 800° C., there is a concern that material change or deformation of the metal counter electrode 4 may occur. In addition, although not particularly limited, commonly, a baking time is approximately 10 minutes to 10 hours.

### Example 1

The counter electrode 7 was manufactured as follows.

First, an n-methylpyrrolidone solution of a polyamide imide resin (VYLOMAX manufactured by TOYOBO CO., LTD.) as a resin binder, and graphite and carbon black as the conductive material were added to an n-methylpyrrolidone (NMP) that is a solvent, and the resultant mixture was stirred and dispersed to prepare a paste-like dispersed solution. The dispersed solution was set as slurry for the conductive primer layer 5. A mixing ratio of the respective materials of the slurry for the conductive primer layer 5 was set to, in terms of mass ratio, graphite:carbon black:polyamide imide resin:NMP=10:10:12:68.

Next, a titanium plate which was formed from pure titanium TP340C and had a thickness of 1 mm was prepared as the metal counter electrode 4.

Next, the slurry for the conductive primer layer 5 was applied onto the entirety of one main surface of the titanium plate by a spin coating method to obtain the metal counter electrode 4 having a coated film. Then, the metal counter electrode 4 was heated and dried for 30 minutes with a hot plate of 200° C. to evaporate a solution in the coated film that was obtained, whereby the metal counter electrode 4 having the conductive primer layer 5 was obtained. The thickness of the conductive primer layer 5 that was obtained was approximately 3.5 μm.

Next, ketjen black and graphite as carbon, titanium oxide as an inorganic binder, and ethyl cellulose as an organic binder were added to terpineol that is a solvent, and the resultant mixture was stirred and dispersed to prepare a paste-shape dispersed solution, and the dispersed solution was set as the paste for screen printing. A mixing ratio of the respective materials of the paste for screen printing was set to, in terms of mass ratio, ketjen black:graphite:titanium oxide:ethyl cellulose:terpineol=8:8:5:3.5:75.5.

Next, the paste for screen printing as a coating material was printed on the entirety of a surface of the conductive primer layer 5 that was obtained using a screen printer (LS-100, manufactured by NEWLONG SEIMITSU KOGYO CO., LTD.). Then, the conductive primer layer 5 was heated and dried with a hot plate of 100° C. to evaporate a solution in the coated film that was obtained, whereby the metal counter electrode 4 having a carbon layer on the conductive primer layer 5 was obtained.

Next, baking of the carbon layer that was obtained was carried out. The carbon layer was baked in such a manner that a temperature was raised to 400° C. in 1.5 hours, and retention was carried out at 400° C. for 30 minutes. According to this process, the ethyl cellulose was completely decomposed and removed, and thus the metal counter electrode 4 having the catalyst layer 6 on the conductive primer layer 5 was obtained. The thickness of the catalyst layer 6 that was obtained was approximately 35 μm.

According to the above-described processes, the counter electrode 7 that was intended was manufactured.

### Example 2

The counter electrode 7 was manufactured in the same manner as Example 1 except that when preparing the slurry for the conductive primer layer 5, an aramid resin (an NMP solution of polymetaphenylene isophthalamide) that is a completely aromatic polyamide resin having a benzene nucleus at a main chain was used in place of the polyamide imide resin as the resin binder.

### Example 3

The counter electrode 7 was manufactured in the same manner as Example 1 except that when preparing the slurry for the conductive primer layer 5, a polyimide resin (varnish (U-Varnish manufactured by UBE INDUSTRIES, LTD.) in which polyamic acid that is a precursor of polyimide is dissolved) was used in place of the polyamide imide resin as the resin binder.

### Example 4

The counter electrode 7 was manufactured in the same manner as Example 1 except that an SUS304 plate was used in place of the titanium plate as the metal counter electrode 4.

### Example 5

The counter electrode 7 was manufactured in the same manner as Example 1 except that an Al-2017 plate was used in place of the titanium plate as the metal counter electrode 4.

### Example 6

The counter electrode 7 was manufactured in the same manner as Example 1 except that an SUS430 substrate was used in place of the titanium plate as the metal counter electrode 4.

### Comparative Example 1

The counter electrode 7 was manufactured in the same manner as Example 1 except that when preparing the slurry for the conductive primer layer 5, a polyvinylidene fluoride (PVDF) -based resin (#1300 manufactured by KUREHA CORPORATION) was used in place of the polyamide imide resin as the resin binder.

### Comparative Example 2

The counter electrode 7 was manufactured in the same manner as Example 1 except that when preparing the slurry for the conductive primer layer 5, a polytetrafluoroethylene (PTFE) resin (VT471 manufactured by DAIKIN INDUSTRIES, ltd.) was used in place of the polyamide imide resin as the resin binder.

### Comparative Example 3

The counter electrode 7 was manufactured in the same manner as Example 1 except that when preparing the slurry for the conductive primer layer 5, an acrylic resin was used in place of the polyamide imide resin as the resin binder.

### Comparative Example 4

A titanium plate having a thickness of 1 mm was prepared as the metal counter electrode 4.

Next, the paste for screen printing prepared in Example 1 as a coating material was printed on the entirety of one main surface of the titanium plate using a screen printer (LS-100, manufactured by NEWLONG SEIMITSU KOGYO CO., LTD.) to obtain the metal counter electrode 4 having a coated film. Then, the metal counter electrode 4 was heated and dried with a hot plate of 100° C. to evaporate a solution in the coated film that was obtained, whereby the metal counter electrode 4 having a carbon layer was obtained. Besides this, the counter electrode 7 was manufactured in the same manner as Example 1.

Table 1 indicates materials of the resin binder that was used in the conductive primer layer 5 of the counter electrodes 7 of Examples 1 to 6, and Comparative Examples 1 to 4, materials of the metal counter electrode 4, and measurement results of surface resistivity (Ω/square) of the catalyst layer 6 after baking at 400° C. The surface resistivity was measured by 4-terminal 4-probe method using a resistivity meter Loresta-GP (MCP-T600 manufactured by Mitsubishi Chemical Analytech Co., Ltd.). As a 4-terminal probe, a PSP probe (type MCP-TP06P) was used.

TABLE 1

| | | | Surface |
|---|---|---|---|
| | | | resistivity |
| | | Metal counter | after baking at |
| | Resin binder | electrode | 400° C. |
| Example 1 | Polyamide imide | Ti | 1.1 × 10−3 Ω/□ |
| Example 2 | Aramid | Ti | 1.2 × 10−3 Ω/□ |
| Example 3 | Polyimide | Ti | 1.1 × 10−3 Ω/□ |
| Example 4 | Polyamide imide | SUS-304 | 8.3 × 10−4 Ω/□ |
| Example 5 | Polyamide imide | Al-2017 | 7.7 × 10−4 Ω/□ |
| Example 6 | Polyamide imide | SUS-430 | 9.3 Ω/□ |
| Comparative | Polyvinylidene | Ti | Peeling |
| Example 1 | fluoride | | |
| Comparative | | Ti | Peeling |
| Example 2 | | | |
| Comparative | Acrylic resin | Ti | Peeling |
| Example 3 | | | |
| Comparative | None | Ti | 1.1 × 10−3 Ω/□ |
| Example 4 | | | |

From Table 1, with regard to the surface resistivity (sheet resistance) (Ω/square) of the catalyst layer 6 in respective examples and comparative examples, the counter electrode 7 of Examples 1 to 6 and Comparative Example 4 exhibited a satisfactory value, and the counter electrode 7 of Examples 4 and 5 exhibited a particularly satisfactory value. In the counter electrode 7 of Comparative Examples 1 to 3, peeling from the metal counter electrode 4 occurred at a baking stage, and thus the surface resistivity of the catalyst layer 6 could not be measured.

From the results, when the conductive primer layer 5 was constituted by using at least one resin selected from a group consisting of a polyamide imide resin, a polyamide resin, and a polyimide resin as a resin binder, it was clear that even when the conductive primer layer 5 was baked at 400° C., peeling from the metal counter electrode 4 did not occur. In addition, it was clear that the surface resistivity of the catalyst layer 6 after baking was substantially the same value as a case in which the catalyst layer 6 was formed directly on the metal counter electrode 4. The reason of this phenomenon is considered as follows. Since at least one resin selected from a group consisting of the polyamide imide resin, the polyamide resin, and the polyimide resin was used as the binder resin of the conductive primer layer 5, the scale of a structure formed by physical binding between the carbon blacks that were conductive carbons contained in the conductive primer layer 5 was large, and thus more electrons could be migrated. In addition, since the binding property of an interface between the conductive primer layer 5 and the metal counter electrode 4, and an interface between the conductive primer layer 5 and the catalyst layer 6 was improved, a binding area increased, and thus an interface resistance at the binding portion decreased. In addition, when the counter electrode 7 was constituted by using SUS-304 or Al-2017 for the metal counter electrode 4, it was clear that the surface resistance value of the catalyst layer 6 was lower than that of a case in which the catalyst layer 6 was formed directly on the metal counter electrode 4. This phenomenon is considered to be because the electrical resistivity of the SUS-304 and Al-2017 is lower than that of titanium. The SUS-304 and Al-2017 are materials that are deficient in electrolytic solution resistance compared to titanium, but the conductive primer layer 5 also has a function of a protective layer against an electrolytic solution in addition to the conductive intermediate layer. Accordingly, even though the materials have low electrolytic solution resistance, the materials may be used as the metal counter electrode 4.

Next, for further comparison of the binding property between the conductive primer layer 5 and the metal counter electrode 4 of the respective examples and respective comparative examples, a binding property before baking the conductive primer layer 5 and a binding property after baking the conductive primer layer 5 were compared to each other.

Specifically, slurry for the conductive primer layer 5 was prepared by a method according to each of the respective examples and comparative examples, the slurry for the conductive primer layer 5 was applied on the metal counter electrode 4, and was heated and dried at 200° C. Then, the conductive primer layer 5 was baked at 400° C.

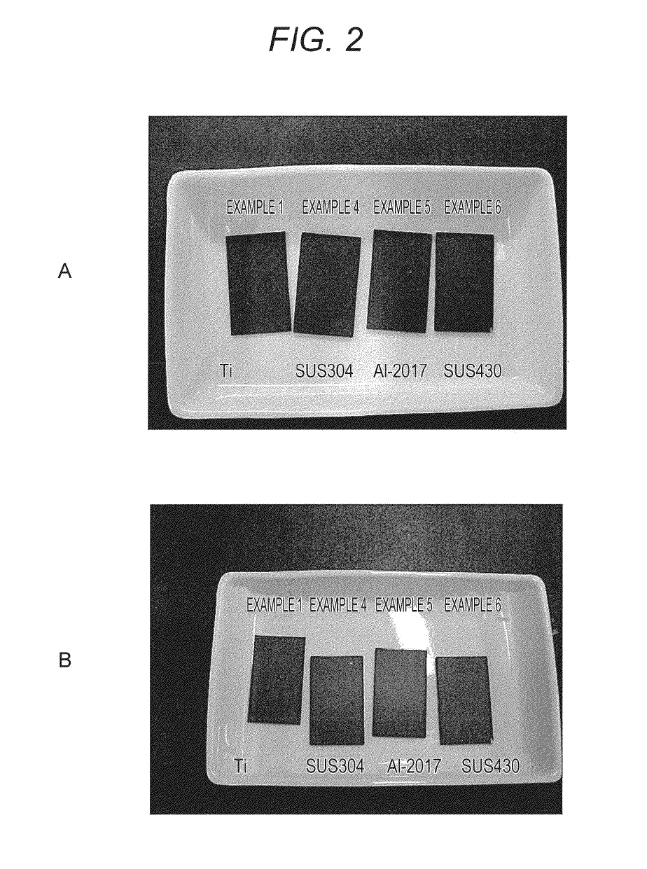

FIG. 2A is a photograph illustrating a surface of the conductive primer layer 5 after the conductive primer layer 5 is formed on the metal counter electrode 4 by each method of Examples 1, 4, 5, and 6, and the conductive primer layer 5 is heated and dried at 200° C., and the surface is strongly rubbed with a non-woven wiper.

FIG. 2B is a photograph illustrating a surface of the conductive primer layer 5 after the above-described heated and dried conductive primer layer 5 is baked at 400° C., and the surface is strongly rubbed with a non-woven wiper.

As illustrated in FIGS. 2A and 2B, in the conductive primer layer 5 manufactured by each method of the examples, even when a strong frictional force was applied to the conductive primer layer 5 before the baking and after the baking, peeling of the conductive primer layer 5, or the like did not occur. According to this result, it is clear that the conductive primer layer 5 in each of Examples 1, 4, 5, and 6 maintains satisfactory binding strength with the metal counter electrode 4 even before the baking and after the baking.

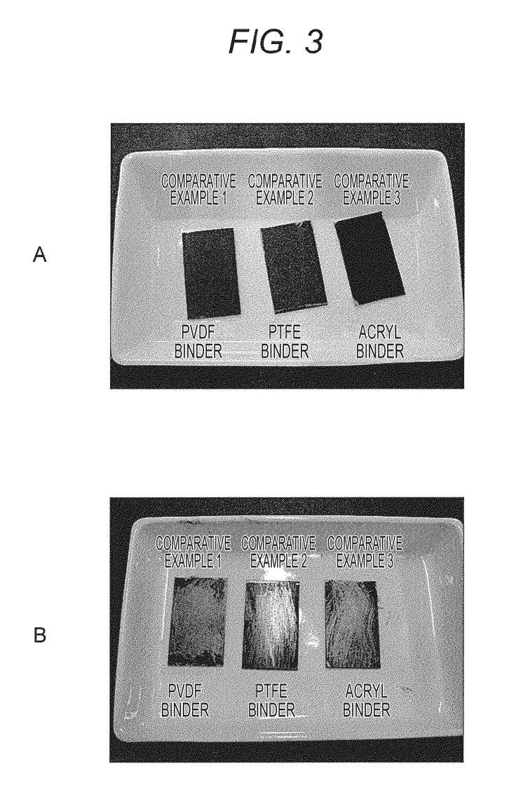

On the other hand, FIG. 3A is a photograph illustrating a surface of the conductive primer layer 5 after the conductive primer layer 5 is formed on the metal counter electrode 4 by each method of Comparative Examples 1 to 3, and the conductive primer layer 5 is heated and dried at 200° C., and the surface is strongly rubbed with a non-woven wiper.

FIG. 3B is a photograph illustrating a surface of the conductive primer layer 5 after the above-described heated and dried conductive primer layer 5 is baked at 400° C., and the surface is strongly rubbed with a non-woven wiper.

As illustrated in FIGS. 3A and 3B, in the conductive primer layer 5 manufactured by each method of Comparative Examples 1 to 3, even when a strong frictional force was applied to the conductive primer layer 5 before the baking, peeling of the conductive primer layer 5, or the like did not occur. On the other hand, in the conductive primer layer 5 after the baking, when the strong frictional force was applied to the conductive primer layer 5, the conductive primer layer 5 was peeled off, and thus the metal counter electrode 4 as a substrate was exposed. From these results, it is clear that the conductive primer layer 5 manufactured by each method of Comparative Examples 1 to 3 has satisfactory binding strength with the metal counter electrode 4 before the baking, but cannot maintain the binding strength with the metal counter electrode 4 after high-temperature baking, particularly, at 400° C.

From these results, it is clear that in the counter electrode 7 provided with the conductive primer layer 5 that contains the conductive carbon and at least one resin selected from a group consisting of the polyamide imide resin, the polyamide resin, and the polyimide resin as the resin binder, even when being baked at 400° C., binding between the conductive primer layer 5 and the metal counter electrode 4 and between the conductive primer layer 5 and the catalyst layer 6 are satisfactorily maintained. The main cause of this result is considered to be because the polyamide imide resin, the polyamide resin, the polyimide resin, and derivatives thereof have very excellent heat resistance, and are materials that are very stable in a high-temperature atmosphere.

As described above, since the counter electrode 7 for a dye-sensitized photoelectric conversion element is configured to have the conductive primer layer 5 between the metal counter electrode 4 and the catalyst layer 6, the metal counter electrode 4 and the catalyst layer 6 are strongly bound through the conductive primer layer 5, and the conductive primer layer 5 retains lots of conductive paths and thus has high electrical conductivity. Accordingly, more electrons may be allowed to migrate between the metal counter electrode 4 and the catalyst layer 6. In addition, in a case where the resin binder that constitutes the conductive primer layer 5 is composed of at least one resin selected from a group consisting of the polyamide imide resin, the polyamide resin, and the polyimide resin, particularly, the metal counter electrode 4 and the catalyst layer 6 may be strongly bound through the conductive primer layer 5, and thus the interface electrical resistance value at an interface between the conductive primer layer 5 and the metal counter electrode 4 and between the conductive primer layer 5 and the catalyst layer 6 may be reduced. Furthermore, since the above-described resin binder is used, an application process is possible during manufacturing of the counter electrode 7 for a dye-sensitized photoelectric conversion element, a large-sized facility is not necessary for the manufacturing, and an inexpensive material may be selected as the conductive material. Accordingly, the counter electrode 7 for a dye-sensitized photoelectric conversion element may be manufactured at the low cost. In addition, even when the conductive primer layer 5 is heated to a baking temperature of the catalyst layer 6 during manufacturing of the counter electrode 7 for a dye-sensitized photoelectric conversion element, material change of the resin binder is not likely to occur, and thus the binding between the binder layer 5 and the metal counter electrode 4 and between the binder layer 5 and the catalyst layer 6 may be strongly maintained. According to these, even when a high-temperature baking process is included in manufacturing processes, the metal counter electrode 4 and the catalyst layer 6 are strongly bound through the conductive primer layer 5, and thus the counter electrode 7 for a high-performance dye-sensitized photoelectric conversion element which has higher electrical conductivity and excellent catalytic performance may be obtained. Particularly, in a case where the conductive material is composed of conductive carbon, and the resin binder which is composed of at least one resin selected from a group consisting of the polyamide imide resin, the polyamide resin, and the polyimide resin, a large-sized carbon black structure may be formed in the conductive primer layer 5, and thus lots of conductive paths are retained. Accordingly, the conductive primer layer 5 having high electrical conductivity may be obtained. According to the first embodiment, since the conductive primer layer 5 and the catalyst layer 6 in the counter electrode 7 for a dye-sensitized photoelectric conversion element are constituted by the conductive carbon layer and a carbon catalyst layer without using a platinum material or the like, a large-sized facility is not necessary for the manufacturing. In addition, since an expensive platinum material is not used, the counter electrode 7 for the dye-sensitized photoelectric conversion element may be manufactured at the low cost.

### 2. Second Embodiment

[Dye-Sensitized Photoelectric Conversion Element]

Next, a dye-sensitized photoelectric conversion element according to a second embodiment will be described.

In the second embodiment, the counter electrode for a dye-sensitized photoelectric conversion element according to the first embodiment is used as a counter electrode for a dye-sensitized photoelectric conversion element.

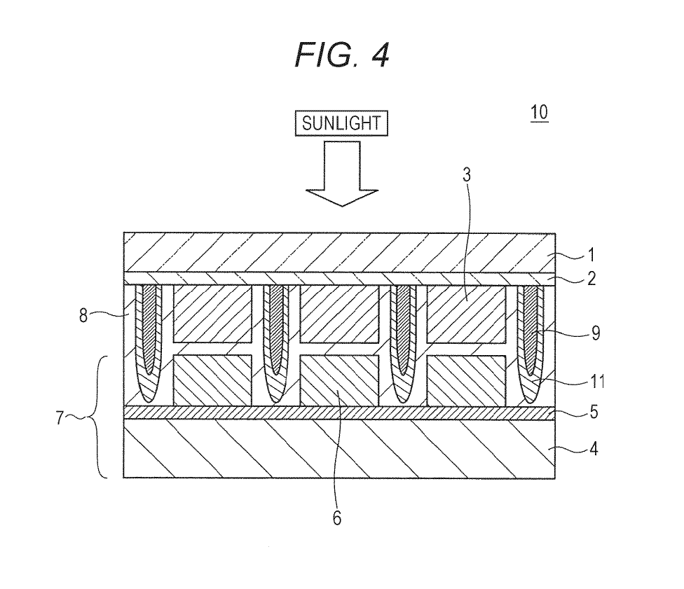

FIG. 4 is a cross-sectional diagram of a main portion, which illustrates a basic configuration of a dye-sensitized photoelectric conversion element 10 according to the second embodiment.

As illustrated in FIG. 4, in the dye-sensitized photoelectric conversion element 10, a transparent electrode 2 is provided on one main surface of a transparent substrate 1. A plurality of current collector wires 9 and a plurality of porous electrodes 3 are formed on the transparent electrode 2 in an alternate manner in a cross-sectional width direction. A current collector wire protective layer 11 is provided on a surface of the current collector wire 9. One kind or a plurality of kinds of photosensitizing dyes (not illustrated) is bonded to the porous electrode 3. On the other hand, as a counter electrode 7, the counter electrode according to the first embodiment is used. In addition, an electrolyte layer 8 formed from an electrolytic solution is filled between the porous electrode 3 and the current collector wire 9 on the transparent substrate 1, and the counter electrode 7. A catalyst layer 6 and the porous electrode 3 are opposite to each other through the electrolyte layer 8. Outer peripheral portions of the transparent substrate 1 and the metal counter electrode 4 are sealed with a sealing material (not illustrated).

As the porous electrode 3, typically, a porous semiconductor layer obtained by sintering semiconductor fine particles is used. The photosensitizing dye is adsorbed onto the surface of the semiconductor fine particles. As a material of the semiconductor fine particles, an elemental semiconductor represented by silicon, a compound semiconductor, a semiconductor having a perovskite structure, and the like may be used. As these semiconductors, an n-type semiconductor in which a conduction-band electron serves as a carrier under optical excitation to cause an anode current is preferable. Specifically, for example, semiconductors such as titanium. oxide (TiO₂), zinc oxide (ZnO), tungsten oxide (WO₃), niobium oxide (Nb₂O₅), strontium titanate (SrTiO₃), and tin oxide (SnO₂) are used. Among these semiconductors, titanium oxide (TiO₂), particularly, anatase type TiO₂ is preferably used. However, a kind of the semiconductor is not limited thereto, and two or more kinds of semiconductors may be used in a mixing manner or a complexation manner as necessary. In addition, the shape of the semiconductor fine particles may be any shape of a particle shape, a tube shape, a rod shape, and the like.

The particle size of the semiconductor fine particles is not particularly limited, but an average particle size of primary particle size is preferably 1 nm or 200 nm, and more preferably 5 nm to 100 nm. In addition, particles having a size larger than semiconductor fine particles may be mixed to scatter incident light with the particles and to improve a quantum yield. In this case, an average particle size of particles that are additionally mixed is preferably 20 nm to 500 nm, but the particles that are additionally mixed are not limited thereto.

It is preferable that the porous electrode 3 have a large actual surface area in order for the photosensitizing dye as many as possible to be bonded thereto. The actual surface area includes mesopores of the semiconductor particles that constitute the porous electrode 3, and the like. The actual surface area in a state in which the porous electrode 3 is formed on the transparent electrode 2 is preferably 10 or more times an area (projection area) of an outer surface of the porous electrode 3, and more preferably 100 or more times. The upper limit of this ratio is not particularly limited, but commonly, the ratio is approximately 1000 times.

Basically, the porous electrode 3 may have any shape as long as the porous electrode 3 has a configuration of coming into contact with the transparent electrode 2 or the current collector wire 9. However, particularly, in a case of a configuration in which the current collector wire 9 is provided to the transparent electrode 2, the shape of the porous electrode 3 is appropriately selected depending on the shape of the current collector wire 9.

As the shape of the porous electrode 3, particularly, in a case where the thickness of the current collector wire 9 is larger than that of the porous electrode 3, a column body is preferable. Specific examples of the shape of the bottom surface of the column body include a triangular shape, a rectangular shape, a trapezoidal shape, a polygonal shape, a circular shape, an elliptical shape, a part of these shapes, and the like. In addition, the bottom surface of the column body may be one kind of shape among the shapes stated above or a shape obtained in combination of the plurality of shapes. In addition, the shape and area of the bottom surface of the column body may be constant or may vary in a direction in which the column body extends. In addition, typically, a direction in which the column body extends is the vertical direction, but the column body may extend in an arbitrary angular direction. In addition, the column body may be a rectangular column body that extends in a constant direction, or a curved column body that extends while the direction varies. As the shape of the porous electrode 3, among the shapes exemplified above, a shape of a square column body that is a rectangular column body having a rectangular bottom surface is preferable, but the shape of the porous electrode 3 is not limited thereto.

In addition, the thickness of the porous electrode 3 is preferably 0.1 μm to 100 μm, more preferably 1 μm to 50 μm, and still more preferably 3μm to 30 μm. The reason of this limitation is as follows. When the thickness of the porous electrode 3 is 0.1 μm or less, since the number of semiconductor fine particles contained per unit projection area is small, the amount of the photosensitizing dye cable of being retained in the unit projection area is small, and thus light absorption cannot be carried out in an efficient manner. In addition, when the thickness of the porous electrode 3 exceeds 100 μm, a diffusion distance until electrons, migrated from the photosensitizing dye to the porous electrode 3, reach the transparent electrode 2 increases, and thus the loss of electrons due to charge re-coupling in the porous electrode 3 also increases.

As a material that constitutes the current collector wire 9, a material having high electrical conductivity is appropriately selected, and examples of the material include a metal material, a carbon material, a conductive polymer, and the like. As the metal material, a metal simple substance, an alloy, and the like may be exemplified. Examples of the metal simple substance include gold (Au), silver (Ag), copper (Cu), zinc (Zn), iron (Fe), platinum (Pt), nickel (Ni), aluminum (Al), and the like. Examples of the alloy include an alloy containing the metal simple substances exemplified above, and the like. In addition, examples of the carbon material include graphite, amorphous carbon (glassy carbon), a carbon fiber, activated charcoal, petroleum coke, fullerenes such as C₆₀ and C₇₀, single-layer or multi-layer carbon nanotube, and the like. Examples of the conductive polymer include polyaniline, polypyrrole, polythiophene, derivatives of these, and the like. Among the materials exemplified above, particularly, silver (Ag) and aluminum (Al) are preferable, but the material that constitutes the current collector wire 9 is not limited thereto. In addition, the material of the current collector wire 9 may be a conductive resin obtained by mixing at least one of the materials exemplified above as a filler in a resin as a base material.

In addition, basically, the shape of the current collector wire 9 may be any shape as long as electrons generated in the porous electrode 3 may be taken out to the outside, but the shape of the current collector wire 9 is appropriately selected depending on the shape of the porous electrode 3 that is provided adjacently thereto. Typically, as the shape of the current collector wire 9, a column body is selected. Specific examples of the shape of the bottom surface of the column body include a triangular shape, a rectangular shape, a trapezoidal shape, a polygonal shape, a circular shape, an elliptical shape, a part of these shapes, and the like. In addition, the shape of the bottom surface of the column body may be one kind of shape among the shapes exemplified above or a shape obtained in combination of the plurality of shapes. In addition, the shape and area of the bottom surface of the column body may be constant or may vary in a direction in which the column body extends. In addition, typically, a direction in which the column body extends is the vertical direction, but the column body may extend in an arbitrary angular direction. In addition, the column body may be a rectangular column body that extends in a constant direction, or a curved column body that extends while the direction varies. As the shape of the current collector wire 9, among the shapes exemplified above, a shape of a square column body that is a rectangular column body having a rectangular bottom surface is preferable, but the shape of the current collector wire 9 is not limited thereto.

With regard to a type of providing the current collector wire 9, typically, the current collector wire 9 is provided on the transparent electrode 2 in such a manner that at least a part of the current collector wire 9 comes into contact with at least a part of the transparent electrode 2. Particularly, in a case where the current collector wire 9 is a column body, the current collector wire 9 is provided preferably in a configuration in which one side surface or a part of the one side surface of the column body comes into contact with the transparent electrode 2. The current collector wire 9 may be provided in a configuration in which the current collector wire 9 comes into contact with the porous electrode 3 or a configuration in which the current collector wire 9 does not come into contact with the porous electrode 3.

In addition, the thickness of the current collector wire 9 may be larger or smaller than, or may be the same as the thickness of the porous electrode 3. However, when a cross-sectional area of the current collector wire 9 increases, resistivity decreases, and particularly, conduction efficiency when a large current is allowed to flow is improved. Accordingly, it is preferable that the thickness of the current collector wire 9 be larger than the thickness of the porous electrode 3.

In addition, in a case where the current collector wire 9 is provided in such a manner that at least apart thereof comes into contact with at least a part of the porous electrode 3, the current collector wire 9 may be provided in a configuration of being embedded in the porous electrode 3 or in a configuration of protruding from the porous electrode 3. In addition, in a case where at least a part of the current collector wire 9 and at least a part of the porous electrode 3 come into contact with each other, the current collector wire 9 may be provided in such a manner that at least a part thereof comes into direct contact with at least a part of a surface of the transparent substrate 1 on a side opposite to a light incident surface without providing the transparent electrode 2 on the transparent substrate 1. In a case where the current collector wire 9 is provided directly on the surface of the transparent substrate 1, the porous electrode 3 may be provided to come into contact with the surface of the transparent substrate 1 or may be provided to be detached from the surface of the transparent substrate 1. However, the configuration of providing the current collector wire 9 and the porous electrode 3 is not limited thereto.

With regard to specific dimensions of the current collector wire 9, a width is preferably in a range of 0.01 mm to 5 mm, and more preferably in a range of 0.05 mm to 1 mm. On the other hand, the thickness of the current collector wire 9 is preferably in a range of 0.1 μm to 500 μm, more preferably in a range of 1 μm to 50 μm, and still more preferably 5 μm to 30 μm. In addition, the depth length of the current collector wire 9 is appropriately determined depending on the size of the light incident surface of the transparent substrate 1. The width, thickness, and depth length of the current collector wire 9 are not limited to the above-described ranges, but preferably, may be determined in ranges of the above-described numerical values.

The current collector wire protective layer 11 is formed from a material having electrolytic solution resistance, and is provided at at least a part of the surface of the current collector wire 9. Typically, the current collector wire protective layer 11 is configured to surround the entirety of the surface of the current collector wire 9 or the entirety of the surface that comes into contact with the electrolyte layer 8. In a case where the current collector wire 9 is provided to come into contact with the porous electrode 3, it is preferable that the current collector wire protective layer 11 be provided in a configuration of surrounding the entirety of a surface that comes into contact with the porous electrode 3 and the electrolyte layer 8, but the configuration of the current collector wire protective layer 11 is not limited thereto.

A material used for the current collector wire protective layer 11 is appropriately selected from materials excellent in electrolytic solution resistance and solvent resistance, and a metal oxide material, a metal material, and the like may be exemplified. Examples of the oxide metal material include aluminum oxide (Al₂O₃), titanium oxide (TiO₂), zinc oxide (ZnO), tungsten oxide (WO₃), niobium. oxide (Nb₂O₅), strontium. titanate (SrTiO₃), tin oxide (SnO₂), and the like. Examples of the metal material include titanium (Ti), nickel (Ni), niobium (Nb), tantalum (Ta), tungsten (W), stainless steel (SUS), indium-tin composite oxide (ITO), and the like. However, the material of the current collector wire protective layer 11 is not limited thereto.

In addition, it is preferable that the current collector wire protective layer 11 also have a backflow prevention configuration in order for electrons not to migrate from the current collector wire 9 to the electrolyte layer 8.

The transparent substrate 1 is not particularly limited as long as the transparent substrate 1 is a substrate of a material and a shape which are capable of easily transmitting light therethrough, and various materials may be used. Particularly, it is preferable to use a substrate material having high transmittance of visible light. In addition, a material, which has a high blocking performance capable of preventing invasion of moisture or gas to the dye-sensitized photoelectric conversion element 10 from the outside, and which is excellent in solvent resistance or weather resistance, is preferable. As a material of the transparent substrate 1, a transparent inorganic material, a transparent plastic, and the like may be exemplified. Examples of the transparent inorganic material include quartz glass, borosilicate glass, phosphate glass, soda-lime glass, and the like. Examples of the transparent plastic include polyethylene terephthalate, polyethylene naphthalate, polybutylene terephthalate, acetyl cellulose, tetraacetyl cellulose, polyphenylene sulfide, polycarbonate, polyethylene, polypropylene, polyvinylidene fluoride, brominated phenoxy, aramids, polyimides such as polyether imide, polystyrenes, polyarylates, polysulfones such as polyester sulfone, polyolefins, and the like. In addition, the thickness of the transparent substrate 1 is not particularly limited, and may be appropriately selected in consideration of light transmittance and a performance of blocking the inside and outside of the photoelectric conversion element.

The transparent electrode 2 provided on the transparent substrate 1 is a conductive thin film, and preferably, has a sheet resistance as small as possible. The sheet resistance of the transparent electrode 2 is preferably 1 Ω/square to 500 Ω/square, and more preferably 1 Ω/square to 100 Ω/square. The reason of this limitation is as follows. When the sheet resistance exceeds 100 Ω/square, the internal resistance of the transparent electrode 2 significantly increases. In addition, the thickness of the transparent electrode 2 that is a thin film is preferably 100 nm to 500 nm. The reason of this limitation is as follows. When the thickness is smaller than 100 nm, a surface resistance value and an internal resistance increase, and when the thickness exceeds 500 nm, cracking has a tendency to occur in the transparent electrode 2. In addition, as a material that constitutes the transparent electrode 2, a known material may be used, and selected according to necessity. Typically, the material is a metal oxide. Examples of the metal oxide include indium-tin composite oxide (ITO), fluorine-doped tin (IV) oxide (SnO₂ (FTO)), tin (IV) oxide (SnO₂), zinc (II) oxide (ZnO), indium-zinc composite oxide (IZO), and the like. However, the material that constitutes the transparent electrode 2 is not limited thereto, and may be a thin film of a metal or mineral. In the case of the metal thin film, for example, platinum, gold, silver, chromium, copper, tungsten, aluminum, and the like may be exemplified. In addition, the transparent electrode 2 may be configured in combination of two or more kinds of the materials exemplified above.

The photosensitizing dye that is bonded to the porous electrode 3 is not particularly limited as long as the photosensitizing dye exhibits a photosensitizing action, but a photosensitizing dye having an acid functional group that is adsorbed to a surface of the porous electrode 3 is preferable. Generally, a photosensitizing dye having a carboxy group, phosphoric acid group, and the like is more preferable, and among these, a photosensitizing dye having a carboxy group is still more preferable. Specific examples of the photosensitizing dye include a xanthene-based dye, a cyanine-based dye, a basic dye, a porphyrin-based compound, and the like. Examples of the xanthene-based dyes include rhodamine B, rose bengal, eosin, erythrosine, and the like. Examples of the cyanine-based dye include merocyanine, quinocyanine, cryptocyanine, and the like. Examples of the basic dye include phenosafranine, capriblue, thiocin, methylene blue, and the like. Examples of the porphyrin-based compound include chlorophyll, zinc porphyrin, magnesium porphyrin, and the like. As other dyes which are applicable to the photosensitizing dye, for example, azo dyes, phthalocyanine compounds, coumarin-based compounds, bipyridine complex compounds, anthraquinone-based dyes, polycyclic quinone-based dyes, and the like may be exemplified. Among these, a high-quantum-yield dye of a complex of at least one kind of metal selected from a group consisting of ruthenium (Ru), osmium (Os), iridium (Ir), platinum (Pt), cobalt (Co), iron (Fe), and copper (Cu) in which a ligand includes pyridine ring or an imidazolium ring is preferable. Furthermore, among these, particularly, a dye molecule having a wide absorption wavelength region, in which cis-bis(isothiocyanate)-N,N-bis(2,2′-dipyridyl-4,4′-dicarboxylic acid)-ruthenium (II) or tris(isothiocyanate)-ruthenium (II)-2,2′:6′,2″-terpyridine-4,4′,4″-tricarboxylic acid is a basic skeleton, is preferable, but the photosensitizing dye is not limited thereto. In addition, typically, the photosensitizing dyes are used alone, but two or more kinds thereof may be mixed and used. In a case where two or more kinds of photosensitizing dyes are mixed and used, the photosensitizing dyes preferably have an inorganic complex dye which is retained in the porous electrode 3 and has a property of causing MLCT (Metal to Ligand Charge Transfer), and an organic molecular dye which is retained in the porous electrode 3 and has an intramolecular CT (Charge Transfer) property. In this case, the inorganic complex dye and the organic molecular dye are adsorbed to the porous electrode 3 in a different steric conformation. Preferably, the inorganic complex dye has a carboxy group or a phosphono group as a functional group that is bonded to the porous electrode 3. In addition, the organic molecular dye preferably has a carboxy group or phosphono group, a cyano group, an amino group, and a thiol group or thione group in the same carbon as a functional group that is bonded to the porous electrode 3. Specifically, the inorganic complex dye has, for example, a polypyridine complex, and the organic molecular dye is an aromatic polycyclic conjugation-based molecule which has, for example, both an electron-donating group and an electron-accommodating group and has an intramolecule CT property.

As the electrolytic solution that constitutes the electrolyte layer 8, a solution containing redox species (redox couple) may be exemplified. As the redox species, specifically, for example, a combination of iodine (I₂) and an iodide salt of a metal or an organic material, a combination of bromine (Br₂) and a bromide salt of a metal or an organic material, and the like are used. Specific examples of cations that constitute the metal salt include lithium (Li⁺), sodium (Na⁺), potassium (K⁺), cesium (Cs⁺), magnesium (Mg²⁺), calcium (Ca²⁺), and the like. In addition, as cations that constitute the organic material salt, quaternary ammonium ions such as tetraalkyl ammonium ions, pyridinium ions, and imidazolium ions are preferable, and these may be used alone or two or more kinds thereof may be mixed and used.

In addition to the above-described materials, as the electrolytic solution that constitutes the electrolyte layer 8, metal complexes of a combination of ferrocyanic acid salt and ferricyanic acid salt, a combination of ferrocene and a ferricinium ion, and the like, sulfur compounds such as polysodium sulfide and compounds of combination of alkyl thiol and alkyl disulfide, and the like, viologen dyes, a combination of hydroquinone and quinone, and the like may be used.

[Operation of Dye-Sensitized Photoelectric Conversion Element]

Next, an operation of the dye-sensitized photoelectric conversion element 10 according to the second embodiment will be described.

When light is incident, the dye-sensitized photoelectric conversion element 10 operates as a battery in which the counter electrode 7 is set as a positive electrode, and the transparent electrode 2 is set as a negative electrode. The principle of the operation is as follow. In addition, here, it is assumed that FTO is used as a material of the transparent electrode 2, TiO₂ is used as a material of the porous electrode 3, and redox species of I⁻/1₃⁻ are used as a redox couple, but it is not limited to this configuration. In addition, it is assumed that one kind of photosensitizing dye is bonded to the porous electrode 3.

When the photosensitizing dye bonded to the porous electrode 3 absorbs photons that are transmitted through the transparent substrate 1 and the transparent electrode 2 and are incident to the porous electrode 3, electrons in the photosensitizing dye are excited from a ground state (HOMO) to an excited state (LUMO). The electrons that are excited in this manner appear in a conduction band of TiO₂ that constitutes the porous electrode 3 through electrical bonds between the photosensitizing dye and the porous electrode 3, and reach the transparent electrode 2 through the porous electrode 3.

On the other hand, the photosensitizing dye that lost the electrons receives electrons from a reducing agent in the electrolyte layer 8, for example, from I by the following reaction, and generates an oxidizing agent in the electrolyte layer 8, for example, I₃⁻ (a bonded body of I₂ and I⁻).

2I⁻→I₂+2e⁻

I₂+I⁻→I₃⁻

The oxidizing agent generated in this manner reaches the catalyst layer 6 that constitutes the counter electrode 7 by diffusion, receives electrons from the catalyst layer 6 by a reverse reaction of the above-described reaction, and is reduced to the original reducing agent.

I₃⁻→I₂+I⁻

I₂+2e⁻→2I⁻

The electrons transmitted to an external circuit from the current collector wire 9 through the transparent electrode 2 perform electrical work at an external circuit, and then return to the catalyst layer 6 through the metal counter electrode 4 and the conductive primer layer 5 that constitute the counter electrode 7. In this manner, light energy is converted to electrical energy without remaining any change in the photosensitizing dye and the electrolyte layer 8.

[Method for Manufacturing Dye-Sensitized Photoelectric Conversion Element]

Next, a method for manufacturing the dye-sensitized photoelectric conversion element 10 according to the second embodiment will be described.

First, the transparent substrate 1 is prepared. Next, a transparent conductive layer is formed on one main surface of the transparent substrate 1 by a sputtering method to form the transparent electrode 2.

Next, a metal is vacuum-deposited on the transparent electrode 2 in a desired pattern to form the current collector wire 9. In addition, the surface of the current collector wire 9 is oxidized by a heat treatment, an electrical treatment, or a chemical treatment to form the current collector wire protective layer 11. The current collector wire 9 may also be formed by welding, bonding, fusion, application, plating, a sputtering method, various CVD methods, and the like. In addition, the current collector wire 9 may be formed by printing a material obtained by mixing conductive particles and a resin on the transparent electrode 2 by screen printing, and by baking the applied material. The conductive particles are preferably metal particles.

Next, the porous electrode 3 is formed on the transparent electrode 2 on a surface on which the current collector wire 9 is not provided. A method for forming the porous electrode 3 is not particularly limited, but a wet-type film forming method is preferably used in consideration of physical properties, convenience, the manufacturing cost, and the like. With regard to the wet-type film forming method, the following method is preferable. In the method, a paste-like dispersed solution is prepared by uniformly dispersing a powder or a sol of semiconductor fine particles in a solvent such as water, and the dispersed solution is applied or printed on the transparent electrode 2 of the transparent substrate 1. The application method or printing method of the dispersed solution is not particularly limited, and a known method may be used. As the application method, specifically, for example, a dipping method, a spraying method, a wire bar method, a spin coating method, a roller coating method, a blade coating method, a gravure coating method, and the like may be used. In addition, as a printing method, a relief printing method, an offset printing method, a gravure printing method, an intaglio printing method, a rubber plate printing method, a screen printing method, and the like may be used.

In a case of using anatase type TiO₂ as the material of the semiconductor fine particles, as the anatase type TiO₂, powder-like, sol-like, slurry-like goods on the market may be used, particles having a predetermined particle size may be formed according to a known method such as a method for hydrolyzing titanium oxide alkoxide. When using a commercially available powder, it is preferable to remove secondary agglomeration of particles, and it is preferable to carryout crushing of particles using a mortar, a ball mill, or the like during preparation of the paste-like dispersed solution. At this time, acetylacetone, hydrochloric acid, nitric acid, a surfactant, a chelating agent, or the like may be added to the paste-like dispersed solution to prevent particles, in which the secondary agglomeration has been removed, from being agglomerated again. In addition, a polymer such as polyethylene oxide and polyvinyl alcohol, or various kinds of thickening agents such as a cellulose-based thickening agent may be added to the paste-like dispersed solution to increase viscosity of the paste-like dispersed solution.

It is preferable to bake the porous electrode 3 after applying or printing the semiconductor fine particles on the transparent electrode 2 to improve the mechanical strength of the porous electrode 3 by electrical connection between the semiconductor fine particles, and to improve adhesiveness with the transparent electrode 2. A range of a baking temperature is not particularly limited. However, when the temperature is too high, the electrical resistance of the transparent electrode 2 increases, and the transparent electrode 2 may be melted in some cases. Accordingly, commonly, the temperature is preferably 40° C. to 700° C., and more preferably 40° C. to 650° C. In addition, a baking time is also not particularly limited, but the baking time is commonly approximately 10 minutes to 10 hours.

After baking the porous electrode 3, for example, a dipping treatment may be carried out using a titanium tetrachloride solution or a sol of titanium oxide ultra-fine particles having a diameter of 10 nm or less to increase a surface area of the semiconductor fine particles or to increase necking between the semiconductor fine particles. In a case of using a plastic substrate as the transparent substrate 1 that supports the transparent electrode 2, the porous electrode 3 may be formed on the transparent electrode 2 by using a paste-like dispersed solution containing a binding agent, and the porous electrode 3 may be compressed to the transparent electrode 2 by hot pressing.

Next, the transparent substrate 1 on which the porous electrode 3 is formed is immersed in a solution obtained by dissolving the photosensitizing dye in a predetermined solvent to bond the photosensitizing dye to the porous electrode 3.

A method for allowing the photosensitizing dye to be adsorbed onto the porous electrode 3 is not particularly limited. However, the porous electrode 3 may be immersed in a solution obtained by dissolving the photosensitizing dye, for example, in a solvent such as alcohols, nitriles, nitromethane, halogenated hydrocarbon, ethers, dimethyl sulfoxide, amides, N-methylpyrrolidone, 1,3-dimethyl-imidazolidinone, 3-methyl-oxazolidinone, esters, carbonic acid esters, ketones, hydrocarbons, and water, and, or a solution containing photosensitizing dye may be applied onto the porous electrode 3. In addition, deoxycholic acid or the like may be added so as to decrease mutual association of molecules of the photosensitizing dye. In addition, an ultraviolet ray absorber may also be used as necessary. In addition, after the photosensitizing dye is allowed to be adsorbed onto the porous electrode 3, the surface of the porous electrode 3 may be processed using amines to remove the photosensitizing dye that is excessively adsorbed. Examples of the amines include pyridine, 4-tert-butylpyridine, polyvinylpyridine, and the like. In a case where these amines are in a liquid state, these amines may be used as is or may be used after being dissolved in an organic solvent.

Next, the counter electrode 7 is manufactured according to a manufacturing method illustrated in the embodiment, whereby the counter electrode 7 in which the metal counter electrode 4 and the catalyst layer 6 are bound through the conductive primer layer 5 is obtained.

Next, the transparent substrate 1 and the metal counter electrode 4 are disposed to be opposite to each other in such a manner that the porous electrode 3 and the catalyst layer 6 have a predetermined distance, and the current collector wire 9 and the conductive primer layer 5 have a predetermined distance. For example, the distance between the porous electrode 3 and the catalyst layer 6 is preferably 1 μm to 100 μm, more preferably 1 μm to 50 μm. In addition, for example, the distance between the current collector wire 9 and the conductive primer layer 5 is preferably 1 μm to 80 μm, and more preferably 1 μm to 30 μm.

In addition, a sealing material (not illustrated) is formed on the outer peripheral portions of the transparent substrate 1 and the metal counter electrode 4 to form a space in which the electrolyte layer 8 is enclosed, and an electrolytic solution is injected through a liquid injection port (not illustrated) provided to the transparent substrate 1 in advance to form the electrolyte layer 8. Then, the liquid injection port is sealed.

According to the above-described processes, the dye-sensitized photoelectric conversion element 10 that is intended is manufactured.

### Example 7

The dye-sensitized photoelectric conversion element 10 was manufactured in the following manner.

First, as the transparent substrate 1 having the transparent electrode 2, a substrate obtained by processing an FTO substrate (sheet resistance was 10 Ω/square) manufactured by Nippon Sheet Glass Company, Limited at a thickness of 1.1 mm was prepared.

Next, the FTO substrate was immersed in 0.2 mol/1 of a titanium tetrachloride solution at 70° C. for 40 minutes. Then, the FTO substrate was washed with pure water, was rinsed using ethanol, and then was sufficiently dried.

Next, TiO₂ paste PST-24 NRT (manufactured by JGC C&C) was applied onto an FTO layer of the FTO substrate using a circular screen mask having a diameter of 5 mm according to a screen method, whereby a TiO₂ coated film was obtained.

Next, TiO₂ paste PST-400C was overpainted on the TiO₂ coated film that was obtained to obtain a laminated TiO₂ coated film. Then, the laminated TiO₂ coated film that was obtained was baked by carrying out retention at 500° C. for 60 minutes to sinter TiO₂ fine particles on the FTO layer, whereby a TiO₂ sintered body serving as the porous electrode 3 was obtained. The TiO₂ sintered body that was obtained had a circular shape with a diameter of 5 mm and a thickness of 18 μm.

Next, UV exposure was carried out by an excimer lamp for 3 minutes to remove impurities of the TiO₂ sintered body that was prepared and to increase activity.

Next, a dye immersion solution, which was obtained by dissolving 2991 as the photosensitizing dye and DPA (1-decylphosphonic acid) as a co-adsorbent in a mixed solvent of tert-butyl alcohol/acetonitrile (volume ratio was 1:1) as a solvent, was prepared. A mixing ratio of 2991 and DPA was, in terms of molar ratio, 2991:DPA=4:1. Next, the above-described TiO₂ sintered body was immersed in the dye immersion solution that was prepared at room temperature for 24 hours to allow the dye to be carried on the sintered body. The resultant TiO₂ sintered body was washed with acetonitrile, and the sintered body was dried by evaporating the solvent at a dark place. In this manner, the porous electrode 3 on which the photosensitizing dye was carried was obtained.

Meanwhile, 1.0 mol/1 of methoxypropioimidazolium iodide, 0.05 mol/1 of lithium iodide (LiI), 0.10 mol/1 of iodine (I₂), and 0.25 mol/1 of N-butylbenzimidazole (NBB) as an additive were dissolved in 3-methoxypropionitrile (abbreviated as MPN) as a solvent to prepare an electrolytic solution.

Next, the counter electrode 7 was manufactured by the method of Example 1.

Next, the transparent substrate 1 and the metal counter electrode 4 were disposed in such a manner that the porous electrode 3 and the counter electrode 7 were opposite to each other with a predetermined distance. In addition, a sealing material (not illustrated) was formed on the outer peripheral portions of the transparent substrate 1 and the metal counter electrode 4 to form a space in which the electrolyte layer 8 was enclosed, and an electrolytic solution was injected using a liquid feeding pump through a liquid injection port provided to the transparent substrate 1 in advance, and the inside of an element was decompressed to expel air bubbles therein, whereby the electrolyte layer 8 was formed. Then, the liquid injection port was sealed at the glass substrate using a sealing resin.

According to the above-described processes, the dye-sensitized photoelectric conversion element 10 that was intended was manufactured.

### Example 8

The dye-sensitized photoelectric conversion element 10 was manufactured in the same manner as Example 7 except that the counter electrode 7 was manufactured by the method of Example 2.

### Example 9

The dye-sensitized photoelectric conversion element 10 was manufactured in the same manner as Example 7 except that the counter electrode 7 was manufactured by the method of Example 3.

### Comparative Example 5

The dye-sensitized photoelectric conversion element 10 was manufactured in the same manner as Example 7 except that the counter electrode 7 was manufactured by the method of Comparative Example 4.

Table 2 indicates measurement results of conversion efficiency Eff. (%), a current density Jsc (mA/cm²), an open circuit voltage V_{oc} (V), a fill factor FF (%), and a DC resistance R(Ω) when the dye-sensitized photoelectric conversion element 10 of each of Examples 7 to 9 and Comparative Example 5 was irradiated with pseudo sunlight (AM1.5, 100 mW/cm²) after retention for 24 hours from preparation. With regard to retention conditions of the dye-sensitized photoelectric conversion element 10, a temperature was set to 85° C., and humidity was set to 0%.

Table 3 indicates measurement results of the respective values when the dye-sensitized photoelectric conversion element 10 of each of Examples 7 to 9 and Comparative Example 5 was irradiated with pseudo sunlight (AM1.5, 100 mW/cm²) after retention for 500 hours from preparation. With regard to retention conditions of the dye-sensitized photoelectric conversion element 10, the temperature was set to 85° C., and the humidity was set to 0% as described above.

TABLE 2

| | | | After 24 hours | | | | |
|---|---|---|---|---|---|---|---|
| | | | | Current | Open | | |
| | | Metal | Conversion | density | circuit | Fill | DC |
| | Resin | counter | efficiency | Jsc | voltage | factor | resistance |
| | binder | electrode | Eff. (%) | (mA/cm²) | Voc (V) | FF (%) | R (Ω) |
| Example 7 | Polyamide | Ti | 7.71 | 16.4 | 0.712 | 66 | 34 |
| | imide | | | | | | |
| Example 8 | Aramid | Ti | 7.64 | 16.5 | 0.712 | 65 | 35 |
| Example 9 | Polyimide | Ti | 7.56 | 16.3 | 0.714 | 65 | 36 |
| Comparative | None | Ti | 7.67 | 16.3 | 0.713 | 66 | 35 |
| Example 5 | | | | | | | |

TABLE 3

| | | | After 500 hours | | | | |
|---|---|---|---|---|---|---|---|
| | | | | Current | Open | | |
| | | Metal | Conversion | density | circuit | Fill | DC |
| | Resin | counter | efficiency | Jsc | voltage | factor | resistance |
| | binder | electrode | Eff. (%) | (mA/cm²) | Voc (V) | FF (%) | R (Ω) |
| Example 7 | Polyamide | Ti | 6.87 | 17.8 | 0.633 | 61.0 | 41 |
| | imide | | | | | | |
| Example 8 | Aramid | Ti | 6.75 | 17.6 | 0.632 | 60.7 | 42 |
| Example 9 | Polyimide | Ti | 6.72 | 17.5 | 0.632 | 60.8 | 42 |
| Comparative | None | Ti | 6.48 | 17.3 | 0.632 | 59.3 | 48 |
| Example 5 | | | | | | | |

As can be seen from Table 2, the conversion efficiency Eff. (%) after retention for 24 hours from preparation of the dye-sensitized photoelectric conversion element 10 of the respective Examples and the Comparative Example was substantially the same in each case.

From the results, it could be seen that the dye-sensitized photoelectric conversion element 10 using the counter electrode 7 in which the metal counter electrode 4 and the catalyst layer 6 were bound through the conductive primer layer 5 had the same high photoelectric conversion efficiency as the dye-sensitized photoelectric conversion element 10 using the counter electrode 7 in which the catalyst layer 6 was directly bound onto the metal counter electrode 4. This result is considered to be because the conductive primer layer 5 has the same electrical conductivity as the metal counter electrode 4. The main cause of this result is considered as follows. As the resin binder that constitutes the conductive primer layer 5, at least one resin selected from a group consisting of a polyamide imide resin, a polyamide resin, and a polyimide resin was used, and thus an interface resistance of interfaces between the conductive primer layer 5 and the metal counter electrode 4 and between the conductive primer layer 5 and the catalyst layer 6 could be decreased. In addition, the scale of a structure formed by physical binding between the carbon blacks that were conductive carbon contained in the conductive primer layer 5 was large, and thus more electrons could be migrated from the metal counter electrode 4 to the catalyst layer 6.

From Table 3, in the respective Examples and Comparative Example, it can be seen that when a value of the conversion efficiency Eff. (%) of the dye-sensitized photoelectric conversion element 10 after retention for 24 hours from preparation is set to 100%, the value after retention for 500 hours from preparation decreased by approximately 11% in Examples 1 to 3, and the value decreased by approximately 15.5% in Comparative Example 5. In addition, with respect to a value of the fill factor after retention for 24 hours from preparation, the value in Examples 1 to 3 decreased by approximately 7.5%, and the value in Comparative Example 5 decreased by approximately 10%. With respect to a value of the DC resistance after retention for 24 hours from preparation, the value in Examples 1 to 3 increased by approximately 20%, and the value in Comparative Example 5 increased by approximately 37%.

From the results, it becomes apparent that the dye-sensitized photoelectric conversion element 10 using the counter electrode 7 in which the metal counter electrode 4 and the catalyst layer 6 are bound through the conductive primer layer 5 has a high photoelectric conversion efficiency after 500 hours from preparation compared to the dye-sensitized photoelectric conversion element 10 using the counter electrode 7 in which the catalyst layer 6 is directly bound onto the metal counter electrode 4. In addition, it becomes apparent that a decrease in the fill factor after 500 hours from preparation, or an increase in the DC resistance value is further suppressed compared to the dye-sensitized photoelectric conversion element 10 using the counter electrode 7 in which the catalyst layer 6 is directly bound onto the metal counter electrode 4. A main cause of the suppression is considered as follows. Since the conductive primer layer 5 was configured to contain the conductive carbon and at least one resin selected from a group consisting of a polyamide imide resin, a polyamide resin, and a polyimide resin as a resin binder, the conductive primer layer 5 became a non-porous layer, and had high compactness to a degree at which the electrolytic solution could not penetrate into the inside of the conductive primer layer 5, and thus an effect of the electrolytic solution on the inside of the conductive primer layer 5 or on the interface of the binding portion between the metal counter electrode 4 and the conductive primer layer 5 was less.

As described above, according to the dye-sensitized photoelectric conversion element 10 according to the second embodiment, in addition to the same advantage as the counter electrode for a dye-sensitized photoelectric conversion element according to the first embodiment, since the conductive primer layer 5 of the counter electrode 7 is configured to have high compactness to a degree at which the electrolytic solution cannot penetrate into the inside of the conductive primer layer 5, even when the counter electrode 7 comes into contact with the electrolytic solution for a long period of time, the electrolytic solution does not penetrate into the binding interface between the metal counter electrode 4 and the conductive primer layer 5, and thus high electrical conductivity of the counter electrode 7 may be retained for a long period of time. Particularly, in a case where at least one resin selected from a group consisting of a polyamide imide resin, a polyamide resin, and a polyimide resin is used as the resin binder used for the primer layer 5, the effect of the electrolytic solution on the inside of the conductive primer layer 5 or on the interface of the binding portion between the metal counter electrode 4 and the conductive primer layer 5 may be largely decreased. According to this, a decrease in the photoelectric conversion efficiency due to long-term use of the dye-sensitized photoelectric conversion element 10 may be suppressed. In addition, since the entirety of a surface of the metal counter electrode 4 on an electrolyte layer 8 side is covered with the conductive primer layer 5 having high compactness, the conductive primer layer 5 serves as a protective layer, and thus the metal counter electrode 4 does not come into contact with the electrolytic solution. Accordingly, a metal having low electrolytic solution resistance may be used for the metal counter electrode 4. As described above, according to the second embodiment, a material having low electrolytic solution resistance may be used for the metal counter electrode 4, and thus the high-performance dye-sensitized photoelectric conversion element 10 which has a high photoelectric conversion efficiency and in which deterioration in performance is small after long-term use may be obtained.

### 3. Third Embodiment

[Counter Electrode for Dye-Sensitized Photoelectric Conversion Element]

Next, the counter electrode for a dye-sensitized photoelectric conversion element according to the third embodiment will be described.

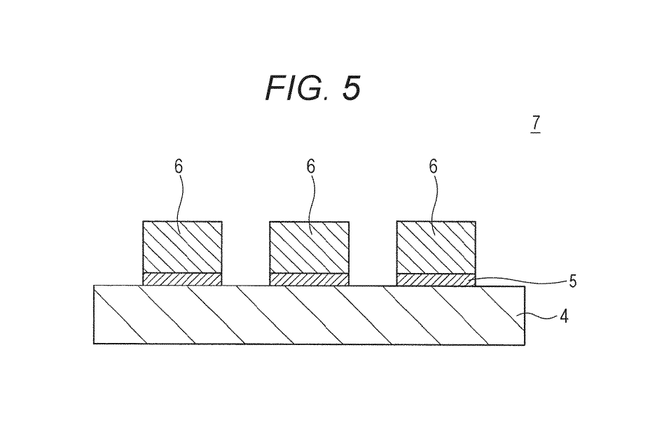

FIG. 5 is a cross-sectional diagram of a main portion, which illustrates a counter electrode 7 for a dye-sensitized photoelectric conversion element according to the third embodiment.

As illustrated in FIG. 5, in the counter electrode 7 for a dye-sensitized photoelectric conversion element, a conductive primer layer 5 that is a conductive intermediate layer is selectively provided on a surface of a metal counter electrode 4. In addition, a catalyst layer 6 is laminated on the conductive primer layer 5, and these components constitute the counter electrode 7. The other configurations are the same as that of the counter electrode 7 for a dye-sensitized photoelectric conversion element according to the first embodiment.

[Method for Manufacturing Counter Electrode for Dye-Sensitized Photoelectric Conversion Element]

Next, a method for manufacturing the counter electrode 7 for a dye-sensitized photoelectric conversion element according to the third embodiment will be described.

First, a metal plate that is the metal counter electrode 4 is prepared.

Next, the conductive primer layer 5 is formed on one main surface of the metal counter electrode 4 with a predetermined distance in a cross-section width direction. Basically, a method for forming the conductive primer layer 5 may be any method, but a wet-type film forming method is preferable. Since the conductive primer layer 5 is selectively formed on the surface of the metal counter electrode 4, in the wet-type film forming method, it is necessary to carry out film formation by pattern application. A screen printing method is preferably used for the film formation by pattern application. In a method for forming the conductive primer layer 5, for example, slurry for the conductive primer layer 5 is prepared, the slurry for the conductive primer layer 5 as a coating material is screen-printed on a surface of the metal counter electrode 4, and a plurality of coated films of the slurry for the conductive primer layer 5, which have a square column shape, are formed on the surface of the metal counter electrode 4 with a predetermined distance. Then, the coated film is dried to remove a solvent, and is heated as necessary, thereby forming the conductive primer layer 5 on the metal counter electrode 4. The other configurations are the same as that of the method for manufacturing the counter electrode 7 for a dye-sensitized photoelectric conversion element according to the first embodiment.

According to the third embodiment, the counter electrode 7 for a dye-sensitized photoelectric conversion element which has the same advantage as the first embodiment may be obtained.

### 4. Fourth Embodiment

[Dye-Sensitized Photoelectric Conversion Element]

Next, a dye-sensitized photoelectric conversion element according to the fourth embodiment will be described.

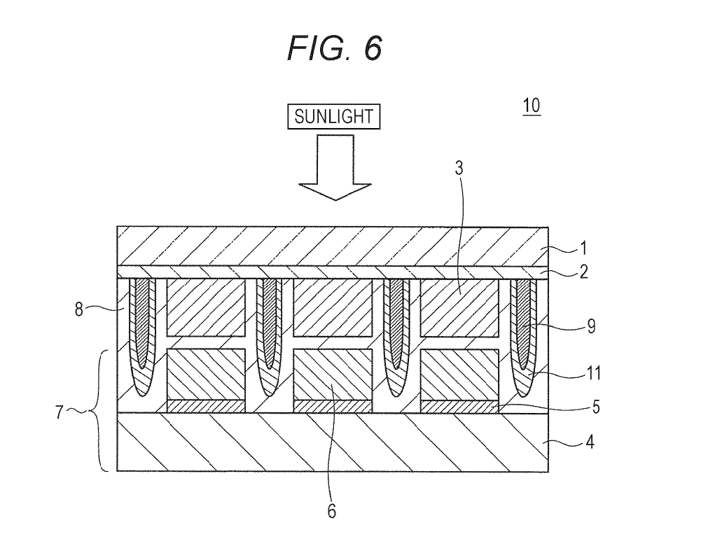

FIG. 6 is a cross-sectional diagram of a main portion, which illustrates a basic configuration of the dye-sensitized photoelectric conversion element 10 according to the fourth embodiment.

As illustrated in FIG. 6, in the fourth embodiment, the counter electrode for a dye-sensitized photoelectric conversion element according to the third embodiment is used as the counter electrode of the dye-sensitized photoelectric conversion element. The other configurations are the same as that of the dye-sensitized photoelectric conversion element according to the second embodiment.

[Operation of Dye-Sensitized Photoelectric Conversion Element]

The operation of the dye-sensitized photoelectric conversion element 10 is the same as the operation of the dye-sensitized photoelectric conversion element 10 according to the second embodiment.

[Method for Manufacturing Dye-Sensitized Photoelectric Conversion Element]

Next, a method for manufacturing the dye-sensitized photoelectric conversion element according to the fourth embodiment will be described.

In the method for manufacturing the dye-sensitized photoelectric conversion element 10, the transparent substrate 1 and the metal counter electrode 4 are disposed to be opposite to each other in such a manner that the porous electrode 3 and the catalyst layer 6 have a predetermined distance, and the current collector wire 9 and the metal counter electrode 4 have a predetermined distance. For example, the distance is preferably 1 μm to 100 μm, and more preferably 1 μm to 50 μm. The other configurations are the same as that of the method for manufacturing the dye-sensitized photoelectric conversion element 10 according to the second embodiment.

As described above, according to the fourth embodiment, the dye-sensitized photoelectric conversion element 10 having the same advantage as the dye-sensitized photoelectric conversion element according to the second embodiment may be obtained.

### 5. Fifth Embodiment

[Counter Electrode for Dye-Sensitized Photoelectric Conversion Element]

Next, a counter electrode for a dye-sensitized photoelectric conversion element according to the fifth embodiment will be described.

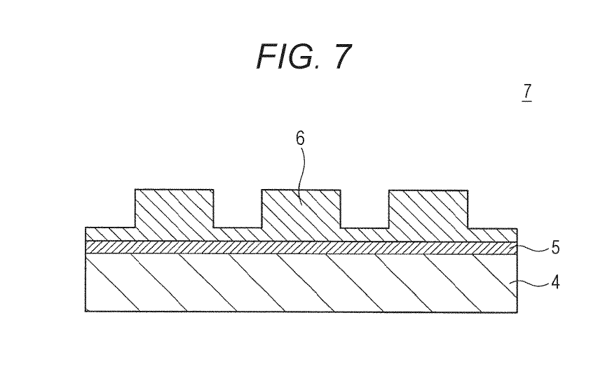

FIG. 7 is a cross-sectional diagram of a main portion, which illustrates the counter electrode for a dye-sensitized photoelectric conversion element according to the fifth embodiment.

As illustrated in FIG. 7, in the counter electrode 7 for a dye-sensitized photoelectric conversion element, a catalyst layer 6 is formed on the entirety of a surface of a conductive primer layer 5, and a plurality of concavo-convex surfaces are formed on the surface of the catalyst layer 6. Specific examples of a configuration of the surface of the catalyst layer 6 include a configuration in which the catalyst layer 6 having a plurality of rectangular convex surfaces with a predetermined distance in a cross-section width direction is laminated on the entirety of a surface of the conductive primer layer 5. The other configurations are the same as that of the counter electrode 7 for a dye-sensitized photoelectric conversion element according to the first embodiment.

[Method for Manufacturing Counter Electrode for Dye-Sensitized Photoelectric Conversion Element]

Next, a method for manufacturing a counter electrode for a dye-sensitized photoelectric conversion element according to the fifth embodiment will be described.

In the method for manufacturing the counter electrode 7 for a dye-sensitized photoelectric conversion element, a paste-like dispersed solution for the catalyst layer 6, which is obtained by uniformly dispersing carbon, an organic binder, and an inorganic binder in a solvent, is prepared.

Next, the dispersed solution for the catalyst layer 6 as a coating material is applied onto the entirety of the surface of the conductive primer layer 5 by a spin coating method, thereby obtaining the metal counter electrode 4 having a coated film for the catalyst layer 6 on the conductive primer layer 5. Next, the dispersed solution for the catalyst layer 6 as a coating material is overpainted on the surface of the obtained coated film for the catalyst layer 6 by screen printing to form a plurality of square column-shaped coated films for the catalyst layer 6 on the surface of the coated film for the catalyst layer 6 with a predetermined distance, thereby obtaining the metal counter electrode 4 having the laminated coated film for the catalyst layer 6 on the conductive primer layer 5. The other configurations are the same as that of the method for manufacturing the counter electrode 7 for a dye-sensitized photoelectric conversion element according to the first embodiment.

As described above, according to the fifth embodiment, the counter electrode 7 for a dye-sensitized photoelectric conversion element, which has the same advantage as the first embodiment, may be obtained.

### 6. Sixth Embodiment

[Dye-Sensitized Photoelectric Conversion Element]

Next, a dye-sensitized photoelectric conversion element according to the sixth embodiment will be described.

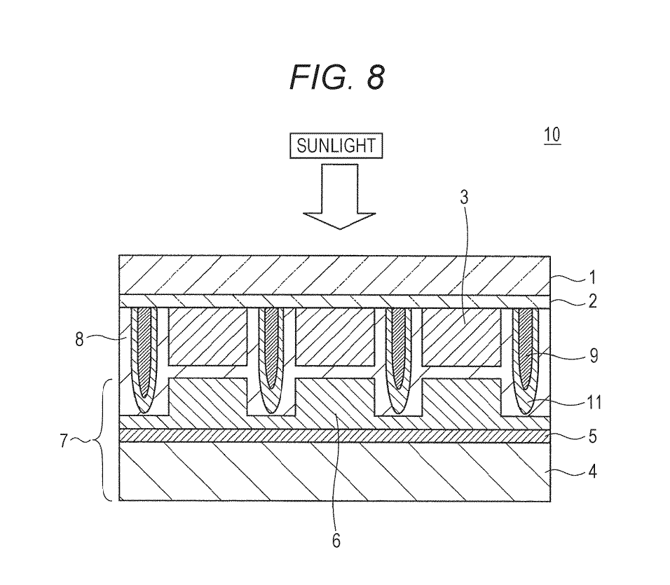

FIG. 8 is a cross-sectional diagram of a main portion, which illustrates a basic configuration of a dye-sensitized photoelectric conversion element 10 according to the sixth embodiment.

As illustrated in FIG. 8, in the dye-sensitized photoelectric conversion element 10 according to the sixth embodiment, the counter electrode for a dye-sensitized photoelectric conversion element according to the fifth embodiment is used as a counter electrode 7. The other configurations are the same as that of the dye-sensitized photoelectric conversion element 10 according to the second embodiment.

[Operation of Dye-Sensitized Photoelectric Conversion Element]

Next, an operation of the dye-sensitized photoelectric conversion element according to the sixth embodiment will be described.

The operation of the dye-sensitized photoelectric conversion element 10 is the same as the operation of the dye-sensitized photoelectric conversion element 10 according to the second embodiment.

[Method for Manufacturing Dye-Sensitized Photoelectric Conversion Element]

Next, a method for manufacturing the dye-sensitized photoelectric conversion element according to the sixth embodiment will be described.

The method for manufacturing the dye-sensitized photoelectric conversion element 10 is the same as the method for manufacturing the dye-sensitized photoelectric conversion element 10 according to the second embodiment.

As described above, according to the sixth embodiment, the dye-sensitized photoelectric conversion element having the same advantage as that of the dye-sensitized photoelectric conversion element according to the second embodiment may be obtained.

### 7. Seventh Embodiment

[Dye-Sensitized Photoelectric Conversion Element]

Next, a dye-sensitized photoelectric conversion element according to the seventh embodiment will be described.

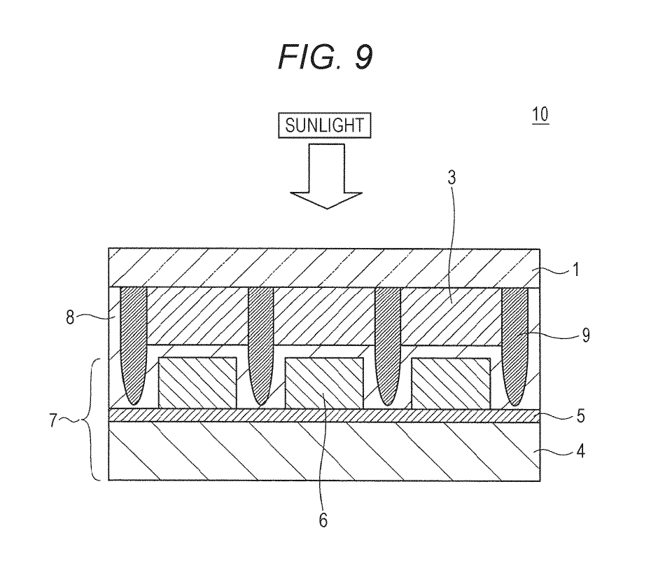

FIG. 9 is a cross-sectional diagram of a main portion, which illustrates a basic configuration of a dye-sensitized photoelectric conversion element 10 according to the seventh embodiment.

As illustrated in FIG. 9, in the dye-sensitized photoelectric conversion element 10 according to the seventh embodiment, a current collector wire 9 is formed directly on the transparent substrate 1 not through the transparent electrode 2, and the current collector wire 9 does not have a current collector wire protective layer. In addition, one counter electrode for a dye-sensitized photoelectric conversion element according to any of the first embodiment, the third embodiment, and the fifth embodiment is used as a counter electrode 7. The other configurations are the same as that of the dye-sensitized photoelectric conversion element 10 according to the second embodiment.

A material for the current collector wire 9 may be appropriately selected from the materials exemplified above, but particularly, a material having high electrolytic solution resistance is preferable. Specifically, for example, titanium (Ti), platinum (Pt), an alloy thereof, and the like are preferable.

[Operation of Dye-Sensitized Photoelectric Conversion Element]

Next, an operation of the dye-sensitized photoelectric conversion element 10 according to the seventh embodiment will be described.

When the photosensitizing dye bonded to the porous electrode 3 absorbs photons that are transmitted through the transparent substrate 1 and are incident to the porous electrode 3, electrons in the photosensitizing dye are excited from a ground state (HOMO) to an excited state (LUMO). The electrons that are excited in this manner appear in a conduction band of TiO₂ that constitutes the porous electrode 3 through electrical bonds between the photosensitizing dye and the porous electrode 3, and reach the current collector wire 9 through the porous electrode 3. The electrons transmitted to an external circuit from the current collector wire 9 perform electrical work in the external circuit, and then return to the catalyst layer 6 through the metal counter electrode 4 and the conductive primer layer 5 that constitute the counter electrode 7. The other configurations are the same as the operation of the dye-sensitized photoelectric conversion element 10 according to the second embodiment.

[Method for Manufacturing Dye-Sensitized Photoelectric Conversion Element]

Next, a method for manufacturing the dye-sensitized photoelectric conversion element 10 according to the seventh embodiment will be described.

First, a transparent plate is prepared as the transparent substrate 1.

Next, a metal is vacuum-deposited on the transparent substrate 1 in a desired pattern to form the current collector wire 9. As a metal that is used, aluminum (Al) is preferable. The current collector wire 9 may be formed by printing a material obtained by mixing conductive particles and a resin on the transparent electrode 2 by screen printing, and by baking the resultant transparent electrode 2. As the conductive particles, metal particles are preferable. The other configurations are the same as that of the method for manufacturing the dye-sensitized photoelectric conversion element 10 according to the second embodiment.

As described above, according to the dye-sensitized photoelectric conversion element according to the seventh embodiment, in addition to the same advantage as the dye-sensitized photoelectric conversion element according to the second embodiment, it is not necessary to form the transparent electrode 2 on the transparent substrate 1, and thus a large-sized facility is not necessary for manufacturing, and the dye-sensitized photoelectric conversion element may be manufactured at the low cost.

### 8. Eighth Embodiment

[Dye-Sensitized Photoelectric Conversion Element]

Next, a dye-sensitized photoelectric conversion element according to the eighth embodiment will be described.

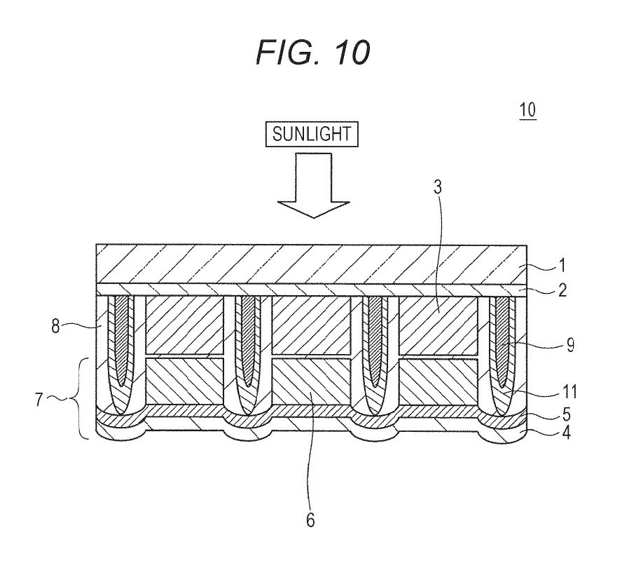

FIG. 10 is a cross-sectional diagram of a main portion, which illustrates a basic configuration of the dye-sensitized photoelectric conversion element 10 according to the eighth embodiment.

As illustrated in FIG. 10, in the dye-sensitized photoelectric conversion element 10, in a state in which the front end of a current collector wire protective layer 11 and a conductive primer layer 5 come into contact with each other, portions of a metal counter electrode 4 and the conductive primer layer 5 thereon, which correspond to spaces between catalyst layers 6, are curved in a convex shape toward a side opposite to a current collector wire protective layer 11. Along with this, flat portions (concavities with respect to the convex curved portions) of the metal counter electrode 4 and the conductive primer layer 5 are adjacent to a porous electrode 3 side. As a result, the distance between the porous electrode 3 and the catalyst layer 6 is smaller than that of the first embodiment. In this case, the distance between an interface of the porous electrode 3 and a transparent electrode 2 and an interface of the catalyst layer 6 and the conductive primer layer 5 is smaller than the height (thickness) of the current collector wire protective layer 11. In addition, for example, total thickness of the porous electrode 3 and the catalyst layer 6 is selected in a thickness equal to the height of the current collector wire protective layer 11 or in a thickness in the vicinity of the height. Typically, the total thickness is selected in a thickness of ±10 μm of the height of the current collector wire protective layer 11.

A material having flexibility as a whole is used for the metal counter electrode 4 and the conductive primer layer 5. Therefore, as the metal counter electrode 4, a metal thin plate, metal foil, a resin film of which surface is coated with a metal film, and the like, which have flexibility, are used. The metal thin plate, the metal foil, and the metal film may be constituted by various metal simple substances or an alloy, but preferably, may be constituted by a metal having high corrosion resistance against an electrolytic solution, for example, titanium. In addition, the thickness of the metal thin plate, the metal foil, and the metal film-attached resin film is selected in order for the entirety of the metal thin plate, the metal foil, or the metal film-attached resin film, and the conductive primer layer 5 to have necessary flexibility. As a preferable specific example of the metal counter electrode 4, titanium foil having a thickness of 0.03 mm may be exemplified. The titanium foil having the thickness of 0.03 mm has sufficient flexibility, and thus the titanium foil may be partially curved into a convex shape in an easy manner, and has high corrosion resistance against the electrolytic solution.

The other configurations of the dye-sensitized photoelectric conversion element 10 are the same as the first embodiment.

[Method for Manufacturing Dye-Sensitized Photoelectric Conversion Element]

Next, a method for manufacturing the dye-sensitized photoelectric conversion element 10 according to the eighth embodiment will be described.

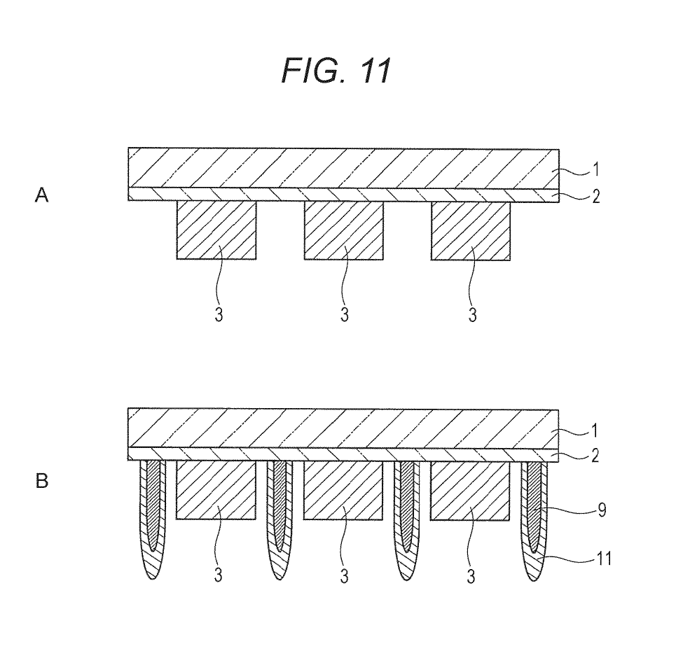

As illustrated in FIGS. 11A and 11B, the porous electrode 3 is formed on the transparent electrode 2 in the same manner as the first embodiment, and then the current collector wire 9 and the current collector wire protective layer 11 that covers the current collector wire 9 are formed on the transparent electrode 2 at a portion between the porous electrodes 3.

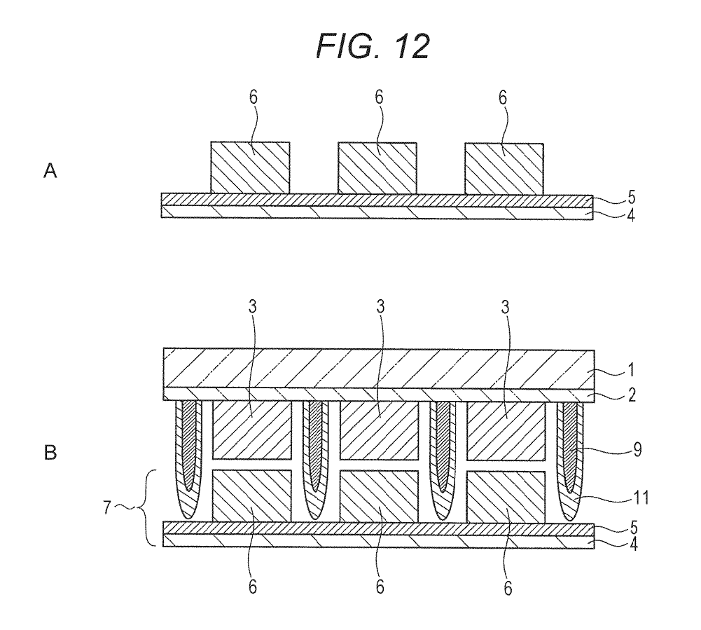

Next, as illustrated in FIG. 12A, the conductive primer layer 5 and the catalyst layer 6 are formed on the metal counter electrode 4 in the same manner as the first embodiment. As the metal counter electrode 4, a material having flexibility is used.

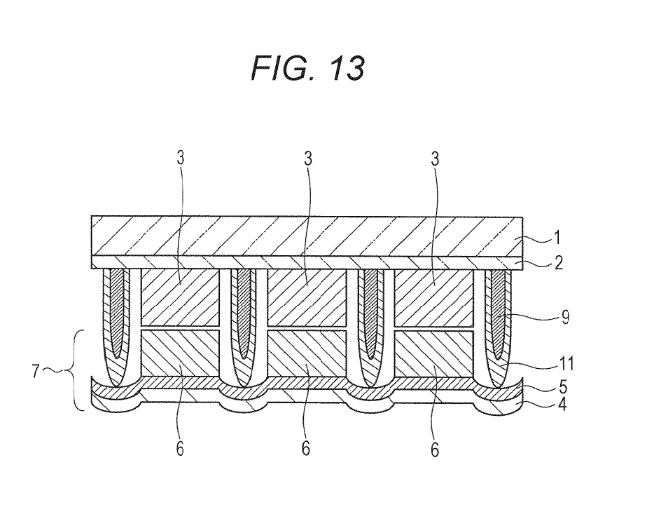

Next, as illustrated in FIG. 12B, the transparent substrate 1 and the counter electrode 7 are maintained to be parallel in such a manner that the porous electrode 3 and the catalyst layer 6 face to each other, and then the transparent substrate 1 and the counter electrode 7 are made to approach to each other. In this manner, when the transparent substrate 1 and the counter electrode 7 are made to approach to each other, the conductive primer layer 5 and the front end of the current collector wire protective layer 11 come into contact with each other. When the transparent substrate 1 and the counter electrode 7 are made to further approach to each other, the entirety of the metal counter electrode 4 and the conductive primer layer 5 at a portion in the vicinity of a contact point starts to be curved in a convex shape toward a side opposite to the current collector wire protective layer 11 by using the contact point as a fulcrum. At a point of time at which the distance between the porous electrode 3 and the catalyst layer 6 reaches a set value, the process of allowing the transparent substrate 1 and the counter electrode 7 to approach to each other is stopped. This state is illustrated in FIG. 13. In a typical example, after the conductive primer layer 5 and the front end of the current collector wire protective layer 11 are brought into contact with each other by moving the counter electrode 7 to approach to the transparent substrate 1 in a fixed state of the transparent substrate 1, the counter electrode 7 is pressed against the transparent substrate 1, and thus the entirety of the metal counter electrode 4 and the conductive primer layer 5 at a portion in the vicinity of the contact portion is curved in a convex shape toward a side opposite to the current collector wire protective layer 11.

Then, a sealing process, a process of injecting the electrolytic solution, and the like are carried out in the same manner as the first embodiment, whereby the intended dye-sensitized photoelectric conversion element 10 illustrated in FIG. 10 is manufactured.

According to the eighth embodiment, in addition to the same advantage as the first embodiment, the following advantages may be obtained. That is, in the first embodiment, even when the distance between the porous electrode 3 and the catalyst layer 6 is made to be further smaller, there is a limitation determined by the height of the current collector wire protective layer 11. On the contrary, according to the eighth embodiment, the distance between the porous electrode 3 and the catalyst layer 6 may be controlled according to the height of the curved portion of the metal counter electrode 4 and the conductive primer layer 5 at a position corresponding to a space between the catalyst layers 6, and thus when the height of the curved portion is made to be sufficiently large, the distance between the porous electrode 3 and the catalyst layer 6 may be made to be sufficiently small, for example, approximately several μm. Accordingly, in the dye-sensitized photoelectric conversion element 10, the electron migration distance in the electrolyte layer 8 between the porous electrode 3 and the catalyst layer 6 may be made greatly small. As a result, the electrical resistance of the dye-sensitized photoelectric conversion element 10 is greatly decreased, and thus the photoelectric conversion efficiency is greatly improved. Further, since it is not necessary for the metal counter electrode 4 to be processed into a concavo-convex shape in advance, an increase in the manufacturing cost of the metal counter electrode 4 may be suppressed, and thus an increase in the manufacturing cost of the dye-sensitized photoelectric conversion element 10 may be suppressed.

Hereinbefore, the embodiments and Examples have been described in detail, but the present disclosure is not limited to the above-described embodiments and Examples, and various modifications may be made on the basis of the technical sprit of the present disclosure.

For example, dimensions, structures, configurations, shapes, materials, and the like that are exemplified in the above-described embodiments and Examples are illustrative only, and different dimensions, structures, configuration, shapes, materials, and the like may be used according to necessity.

In addition, in the above-described eighth embodiment, a metal thin plate, metal foil, a metal film-attached resin film, and the like, which have flexibility, are used as the metal counter electrode 4. However, in the dye-sensitized photoelectric conversion element not using the metal counter electrode 4, a resin film on which a transparent conductive film is formed, and the like may be used in place of the metal counter electrode 4. In addition, the technology in which a metal thin plate, metal foil, a metal film-attached resin film, and the like, which have flexibility, are used as the metal counter electrode 4, and a portion corresponding to the space between the catalyst layers 6 is curved is also applicable to a case in which the conductive primer layer 5 is not formed on the metal counter electrode 4.

In addition, the present technology may have the following configurations as well.

(1) A photoelectric conversion element, including:

an electrolyte layer between a porous electrode and a counter electrode,

wherein the counter electrode includes,

a metal counter electrode,

a conductive intermediate layer provided on the metal counter electrode, and

a catalyst layer provided on the conductive intermediate layer.

(2) The photoelectric conversion element according to (1),

wherein the conductive intermediate layer contains at least one conductive material selected from a group consisting of conductive carbon, fluorine-doped tin oxide, antimony oxide, indium tin oxide, indium gallium zinc oxide, and conductive whisker.

(3) The photoelectric conversion element according to (1) or (2),

wherein the conductive intermediate layer contains the conductive material and a resin.

(4) The photoelectric conversion element according to any of (1) to (3),

wherein the conductive material is conductive carbon particles, and the resin is at least one resin selected from a group consisting of a polyamide imide resin, a polyamide resin, and a polyimide resin.

(5) The photoelectric conversion element according to any of (1) to (4),

wherein the catalyst layer contains carbon and an inorganic binder.

(6) The photoelectric conversion element according to any of (1) to (5),

wherein a thickness of the conductive intermediate layer is 0.2 μm to 10 μm.

(7) The photoelectric conversion element according to any of (1) to (6),

wherein a thickness of the catalyst layer is 5 μm to 200 μm.

(8) The photoelectric conversion element according to any of (1) to (7),

wherein the photoelectric conversion element is a dye-sensitized photoelectric conversion element in which a photosensitizing dye is adsorbed onto the porous electrode.

(9) The photoelectric conversion element according to (8),

wherein the porous electrode is constituted by fine particles composed of a semiconductor.

(10) A method for manufacturing a photoelectric conversion element including an electrolyte layer between a porous electrode and a counter electrode, the method including:

forming the counter electrode by forming a conductive intermediate layer on a metal counter electrode, and forming a catalyst layer on the conductive intermediate layer.

(11) The method for manufacturing a photoelectric conversion element according to (10),

wherein the conductive intermediate layer is formed by laminating a material containing a conductive material on the metal counter electrode, and

the conductive material is at least one material selected from a group consisting of conductive carbon, fluorine-doped tin oxide, antimony oxide, indium tin oxide, indium gallium zinc oxide, and conductive whisker.

(12) The method for manufacturing a photoelectric conversion element according to (10) or (11),

wherein the counter electrode is formed by applying a mixed solution of the conductive material, a resin, and a solvent onto the metal counter electrode, and drying the applied solution to form the conductive intermediate layer, and by forming the catalyst layer on the conductive intermediate layer.

(13) The method for manufacturing a photoelectric conversion element according to any of (10) to (12),

wherein the conductive material is conductive carbon particles, and the resin is at least one resin selected from a group consisting of a polyamide imide resin, a polyamide resin, and a polyimide resin.

(14) The method for manufacturing a photoelectric conversion element according to any of (10) to (13),

wherein the catalyst layer is formed by applying a mixed solution of carbon, an organic binder, an inorganic binder, and a solvent onto the conductive intermediate layer, and by baking the resultant product.

(15) The method for manufacturing a photoelectric conversion element according to any of (10) to (14),

wherein the organic binder is at least one binder selected from a group consisting of ethyl cellulose, carboxymethyl cellulose, methyl cellulose, hydroxyethyl cellulose, polyethylene oxide, polyvinyl pyrrolidone, and carboxyvinyl polymer.

(16) The method for manufacturing a photoelectric conversion element according to any of (10) to (15),

wherein the photoelectric conversion element is a dye-sensitized photoelectric conversion element in which a photosensitizing dye is adsorbed onto the porous electrode.

(17) An electronic apparatus, including:

at least one photoelectric conversion element,

wherein the photoelectric conversion element includes an electrolyte layer between a porous electrode and a counter electrode, and

wherein the counter electrode includes,

a metal counter electrode,

a conductive intermediate layer provided on the metal counter electrode, and

a catalyst layer provided on the conductive intermediate layer.

(18) A counter electrode for a photoelectric conversion element, including:

a metal counter electrode,

a conductive intermediate layer provided on the metal counter electrode, and

a catalyst layer provided on the conductive intermediate layer.

(19) An architecture, including:

at least one photoelectric conversion element and/or a photoelectric conversion element module in which a plurality of the photoelectric conversion elements are electrically connected to each other,

wherein the photoelectric conversion element includes an electrolyte layer between a porous electrode and a counter electrode, and

wherein the counter electrode includes,

a metal counter electrode,

a conductive intermediate layer provided on the metal counter electrode, and

a catalyst layer provided on the conductive intermediate layer.

(20) The architecture according to (19),

at least one of the photoelectric conversion element and/or the photoelectric conversion element module is interposed between two transparent plates.

### REFERENCE SIGNS LIST

1, 101 Transparent substrate
2, 102 Transparent electrode
3, 103 Porous electrode
4, 104 Metal counter electrode
5 Conductive primer layer
6 Catalyst layer
7, 107 Counter electrode
8, 108 Electrolyte layer
9, 109 Current collector wire
10, 100 Dye-sensitized photoelectric conversion element
11, 111 Current collector wire protective layer

1. A photoelectric conversion element, comprising:
an electrolyte layer between a porous electrode and a counter electrode,
wherein the counter electrode includes,
a metal counter electrode,
a conductive intermediate layer provided on the metal counter electrode, and
a catalyst layer provided on the conductive intermediate layer.

2. The photoelectric conversion element according to claim 1,
wherein the conductive intermediate layer contains at least one conductive material selected from a group consisting of conductive carbon, fluorine-doped tin oxide, antimony oxide, indium tin oxide, indium gallium zinc oxide, and conductive whisker.

3. The photoelectric conversion element according to claim 2,
wherein the conductive intermediate layer contains the conductive material and a resin.

4. The photoelectric conversion element according to claim 3,
wherein the conductive material is conductive carbon particles, and the resin is at least one resin selected from a group consisting of a polyamide imide resin, a polyamide resin, and a polyimide resin.

5. The photoelectric conversion element according to claim 4,
wherein the catalyst layer contains carbon and an inorganic binder.

6. The photoelectric conversion element according to claim 5,
wherein a thickness of the conductive intermediate layer is 0.2 μm to 10 μm.

7. The photoelectric conversion element according to claim 6,
wherein a thickness of the catalyst layer is 5 μm to 200 μm.

8. The photoelectric conversion element according to claim 1,
wherein the photoelectric conversion element is a dye-sensitized photoelectric conversion element in which a photosensitizing dye is adsorbed onto the porous electrode.

9. The photoelectric conversion element according to claim 8,
wherein the porous electrode is constituted by fine particles composed of a semiconductor.

10. A method for manufacturing a photoelectric conversion element including an electrolyte layer between a porous electrode and a counter electrode, the method comprising:
forming the counter electrode by forming a conductive intermediate layer on a metal counter electrode, and forming a catalyst layer on the conductive intermediate layer.

11. The method for manufacturing a photoelectric conversion element according to claim 10,
wherein the conductive intermediate layer is formed by laminating a material containing a conductive material on the metal counter electrode, and
the conductive material is at least one material selected from a group consisting of conductive carbon, fluorine-doped tin oxide, antimony oxide, indium tin oxide, indium gallium zinc oxide, and conductive whisker.

12. The method for manufacturing a photoelectric conversion element according to claim 11,
wherein the counter electrode is formed by applying a mixed solution of the conductive material, a resin, and a solvent onto the metal counter electrode, and drying the applied solution to form the conductive intermediate layer, and by forming the catalyst layer on the conductive intermediate layer.

13. The method for manufacturing a photoelectric conversion element according to claim 12,
wherein the conductive material is conductive carbon particles, and the resin is at least one resin selected from a group consisting of a polyamide imide resin, a polyamide resin, and a polyimide resin.

14. The method for manufacturing a photoelectric conversion element according to claim 13,
wherein the catalyst layer is formed by applying a mixed solution of carbon, an organic binder, an inorganic binder, and a solvent onto the conductive intermediate layer, and by baking the resultant product.

15. The method for manufacturing a photoelectric conversion element according to claim 14,
wherein the organic binder is at least one binder selected from a group consisting of ethyl cellulose, carboxymethyl cellulose, methyl cellulose, hydroxyethyl cellulose, polyethylene oxide, polyvinyl pyrrolidone, and carboxyvinyl polymer.

16. The method for manufacturing a photoelectric conversion element according to claim 10,
wherein the photoelectric conversion element is a dye-sensitized photoelectric conversion element in which a photosensitizing dye is adsorbed onto the porous electrode.

17. An electronic apparatus, comprising:
at least one photoelectric conversion element,
wherein the photoelectric conversion element includes an electrolyte layer between a porous electrode and a counter electrode, and
wherein the counter electrode includes,
a metal counter electrode,
a conductive intermediate layer provided on the metal counter electrode, and
a catalyst layer provided on the conductive intermediate layer.

18. A counter electrode for a photoelectric conversion element, comprising:
a metal counter electrode,
a conductive intermediate layer provided on the metal counter electrode, and
a catalyst layer provided on the conductive intermediate layer.

19. An architecture, comprising:
at least one photoelectric conversion element and/or a photoelectric conversion element module in which a plurality of the photoelectric conversion elements are electrically connected to each other,
wherein the photoelectric conversion element includes an electrolyte layer between a porous electrode and a counter electrode, and
wherein the counter electrode includes,
a metal counter electrode,
a conductive intermediate layer provided on the metal counter electrode, and
a catalyst layer provided on the conductive intermediate layer.

20. The architecture according to claim 19,
at least one of the photoelectric conversion element and/or the photoelectric conversion element module is interposed between two transparent plates.
